(19) United States
(12) Patent Application Publication
(10) Pub. No.: US 2004/0193640 A1
(43) Pub. Date: Sep. 30, 2004

(54) Methods and apparatus for the interoperability and manipulation of data in a computer network

(76) Inventors: John E. Armstrong, Santee, CA (US); Marcia R. Armstrong, Santee, CA (US); Dan R. Daffer, El Cajon, CA (US); Robert J. Offerman, Carlsbad, CA (US); Shell L. Pierce, El Cajon, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/822,305

(22) Filed: Apr. 12, 2004

Related U.S. Application Data
(62) Division of application No. 09/836,894, filed on Apr. 17, 2001.

(51) Int. Cl. G06F 17/00

(52) U.S. Cl. 707/103 R

(57) ABSTRACT

A system for exchanging transaction between computers that enables software with different data formats to exchange data. The system maintains a profile of all the parties to the transaction which includes the data formats utilized by each party. Upon initiation of a transaction, the system generates encryption keys unique to the session and all the data transfers are encoded with the newly generated encryption keys.

### BACKGROUND OF THE INVENTION

1. Field of the Invention

The field of the present invention relates the use of a method and system to translate data and share information in one or more formats as stored and used in one system into one or more formats as stored and used by another system. Another aspect of the present invention relates to allowing the computer systems to transmit and receive the data in an encoded and digitally signed form so that it can be securely transmitted and received over a public or private network. Another aspect relates to using computer generated keystrokes to simulate human data entry so that stored data can be input through a software application's graphical user interface.

2. Description of the Related Art

For many years financial, accounting, statistical and other types of encoded data have been stored, manipulated, distributed and eventually transferred from one or more proprietary systems to one or more proprietary destination systems. These systems, which use encoded data, range from simple, manual driven card catalog systems to mainframe computer systems with complex algorithms. One key problem that faced these systems which use encoded data was a lack of the ability to transfer data from one system to another when the two systems used dissimilar formats for data. For example, since card catalog systems use index cards with written text data, and mainframes use, among other things, magnetic media to store data, operators of the two systems had no simple way to take the written data and transfer it into the mainframe computer system.

Under this traditional system, the task of transforming the data and routing it into the destination system was normally accomplished in physical ways such as manual data entry or, in the case of two unique computer implemented systems using divergent data, employing a team of application programmers to design a specific software interface application in order to transform the data on either system so it could be used on the other system. This method required the individual coordination of each system every time a unique data format was newly implemented or altered.

Traditional methods of integrating applications and their related data involve Remote Procedure Call (RPC) mechanisms. An RPC occurs when an application makes a function call to code that is running on a destination computer. This activity requires specialized protocol support to package, send and receive the appropriate messages back and forth between the cooperating computers to service the request. Examples of RPC technologies are DCOM as a part of the Microsoft Component Object Model (COM), IIOP as a part of COBRA, and RMI as a part of Java. These distributed object systems are known to have difficulty with integrating more distributed systems. They rely on a deep knowledge of the destination system to accomplish the interchangeability of information between the systems.

Examples of such systems include Tandem systems which can communicate with Unisys 1100 operating systems across standard network connections. These systems often offer a small set of functionality, allowing the user to change variables and transform data only after each individual application is written and implemented. Additionally, some dedicated computer systems, such as mainframe systems, also have offered limited programmability at the cost of time-consuming procedures which vary from product to product.

In recent years, new technology has made it practical and increasingly popular to store, distribute, manipulate and retrieve data in the form of computer files. These files can be stored in a number of formats, and on numerous types of digital media including hard disks, CD-R or CD-RW discs, DVD discs, random access memory (RAM), and FLASH memory. These data files are stored and manipulated on various servers. A server is a computer in a network shared by multiple users, and a server may refer to both the hardware and software or just the software that performs the service. For example, a web server may refer to the web server software in a computer that also runs other applications, or, it may refer to a computer system dedicated only to the web server application. There could be several dedicated web servers in a large web site. Other examples of specific servers are: an application server, an audio server, a commerce server, a fax server, a file server, an intranet server, a mail server, a merchant server, a modem server, a network access server, a print server, a proxy server, and a remote access server.

A database is a set of related files that is created and managed by a database management system (DBMS). Today, DBMSs can manage any form of data including text, images, sound and video. Database and file structures are always determined by the software and these databases generally reside on one or more servers. Software applications, also located on one or more servers, use data in the databases and the data used by the software is formatted based on a designated or predetermined protocol.

A ‘back office’ is a suite of software products that comprises the client's business system. A back office typically uses a formatting scheme to format the digital data so it can be stored and used by the application. The most popular ‘back office’ type systems are MYOB, Accubooks, and Quickbooks. These software applications would then recognize the format of the data as a format that it would be able to use. The back office would ideally communicate over a network using protocols, some examples being TCP/IP, FTP and SMTP.

A typical business to business solution, using one or more of these protocols, would be a fully integrated system, which generally enables order processing that is linked with core business operations and physical distribution facilities. This fully integrated system may also be based on Electronic Data Interchange (EDI) standards. EDI standards are coordinated nationally and maintained by the American National Standards Institute (ANSI), who acts as a clearing house and information center for national and international standards. Standards are copyrighted and. distributed by the Data Interchange Standards Association, Inc. (DISA) who is the only source for official standards documentation. Examples of EDI transactions are the EDI838 Trading Partner Profile, the EDI850 Purchase Order and the EDI810 Invoice.

Many companies have difficulty establishing links between their own front office functions and their back office functions. A typical product will tie a company's proprietary electronic commerce and call center modules to their manufacturing, financial, sales and marketing modules. An example of a front office application is a field service and sales-force automation application which is designed to help salespeople keep track of leads, customers, orders, and product information. An example of a back office application is an accounting application.

In another example, current e-commerce solutions are generally tied to a specific package which is unable to communicate or transfer data to and from a back office product. An example would be an e-commerce enabled website or a website with a shopping cart which cannot be directly interfaced with a back office product accounting application such as QuickBooks.

In a situation where the front office was not compatible with the back office, a typical user would receive data via a secured server, download it into a format which could then be manually transported and upload it into the client's back office application. Similarly, the data in the client's back office application could also be exported to a file which could then be read by or posted to the front office or another business system.

In a business to business situation, a company doing business on a chemical exchange might post a request for price quote on benzene and get five bids. The buyer might choose the lowest bid, but in most cases, the buyer would call the supplier and handle the transaction offline because the two companies systems aren't able to communicate electronically. The present invention addresses that problem by allowing a company to send and receive data from its back office business application to existing externally based programs located within outside businesses. The present invention would be able to check either its internal registry or a network based registry in a way that allows the buyer's back office purchasing system to automatically look up what data format the seller's computers use. The buyer's system then would send an electronic purchase order in the proper format so that the deal can be consummated online.

Other larger scale projects include Enterprise Resource Planning or ERP. This relates to an integrated information system that serves all departments within an enterprise. Evolving out of the manufacturing industry, ERP implies the use of packaged software rather than proprietary software written by or for one customer. ERP modules may be able to interface with an organization's own software with varying degrees of effort, and, depending on the software, ERP modules may be alterable via the vendor's proprietary tools as well as proprietary or standard programming languages. An ERP system can include software for manufacturing, order entry, accounts receivable and payable, general ledger, purchasing, warehousing, transportation and human resources. The major ERP vendors are SAP, PeopleSoft, Oracle, Baan and J. D. Edwards. Again, each module in each system must be individually synchronized and coordinated with each target system so that interoperability can occur.

Integrating distributed business computer based processes is a difficult task and is frequently prohibitively expensive between organizations or even between computer systems. Many major companies are using expensive proprietary systems to facilitate business process integration. As such, there is a great need for small and medium sized businesses to accomplish similar integration tasks.

Thus, there is currently no adequate means to use data from one back office system and link it to a front office system or another computer's back office system.

### SUMMARY OF THE INVENTION

Several objects for use in the translation and routing of data to be used between systems are described herein. One object of the present invention relates to methods and apparatus for transforming data in one format to another format so that the data can be used by one or more applications. Particularly, the invention facilitates the automatic exchange of business documents and data using EDI as well as other known standard data formats.

Some features of the present invention are: the invention is relatively low cost compared to proprietary systems, the invention works with a LAN as well as a WAN, and the invention combines the capability of using data formats in EDI as well as ASCII, XML or native databases. The present invention can be used as a standalone application in conjunction with a client's commerce server or used through an ASP to provide functionality based on usage.

One object of the present invention relates to methods and apparatus for integrating distributed business computer based processes in a computer network. Another object of the present invention relates to methods and apparatuses for making data standardized and interchangeable between two or more diverse systems in a computer network. Even other inventive objects relate to the use of secure protocols to encode, digitally sign, as well as compress for optimization data as it moves between systems in a computer network.

One inventive aspect of the present invention relates to providing a solution for sharing data between diverse computer applications. Another inventive aspect of the present invention relates to securing the data transmission with the use of one or more identifiers which uniquely encode the data.

Other inventive aspects relate to automating and standardizing data transformation and routing which allows exchanges of that data between two of more systems in a computer network.

Another inventive aspect relates to the ability of the present invention to use existing operating systems, transport mechanisms, business documents and data formats interchangeably. Another inventive aspect relates to providing data interchangeability on a cost effective basis.

Another inventive aspect relates to the ability of the present invention to create, track, and ensure completion of all transactions needed to complete a business conversation.

Even another inventive aspect relates to generating data which can be used in a variety of off the shelf software applications, regardless of their respective formats.

Other inventive aspects of the present invention relate to populating a single consistently formatted database from combinations of data in varying formats.

Another inventive aspect relates to performing accuracy and integrity checks on data submitted in a computer network in the form of a “verification.”

Furthermore, other inventive aspects relate to performing accuracy checks on outside sources of data by confirming the integrity and proper formatting of the data by confirming the data properties with an existing database maintained by the present invention.

### BRIEF DESCRIPTION OF THE DRAWINGS

FIG. 1 is a block diagram of a system describing the interrelationship between the basic components used in activating, initializing and operating the transaction engine environment with a plurality of servers connected in a computer network.

FIG. 2 is a block diagram of relevant components of the web host server 101 of FIG. 1.

FIG. 3 is a block diagram of relevant components of a third party server 102 of FIG. 1.

FIG. 4 is a block diagram of relevant components of the commerce server 103 of FIG. 1.

FIG. 5 is a block diagram of relevant components of the client application server 106 of FIG. 1.

FIG. 6 is a flow diagram of an overview of the activation of system 100.

FIG. 7 is a flow diagram of an overview of the interview process.

FIG. 8 is a flow diagram of the Interview Business Function.

FIG. 9 is a flow diagram detailing the interview for application and utilization information.

FIG. 10 is an overview flow diagram of the loading and activation of objects.

FIG. 11 is a flow diagram of the loading and activation of the Resource Center Object.

FIG. 12 is a flow diagram of the loading and activation of the back office communications object.

FIG. 13 is a flow diagram of the loading and activation of the EDI translator object.

FIG. 14 is a flow diagram detailing the loading and activation of the XML translator object.

FIG. 15 is a flow diagram of the loading and activation of the business to business communications object.

FIG. 16 is an overview flow diagram detailing the loading and activation of the web host communications object.

FIG. 17 is a flow diagram of the initialization of the environment and connectivity of system 100.

FIG. 18 is a flow diagram of the installation of the transport protocol.

FIG. 19 is a flow diagram of the create local profile function.

FIG. 20 is a flow diagram of the responder process.

FIG. 21 is a flow diagram of the initiator's event states utilized for transporting information across a network.

FIG. 22 is a flow diagram of the responder's event states utilized for transporting information across a network.

FIG. 23 is a flow diagram of the transport protocol listener.

FIG. 24 is a flow diagram of the transport protocol's user interface.

FIG. 25 is a flow diagram of the transport protocol shell.

FIG. 26 is a flow diagram of the session request.

FIG. 27 is a flow diagram of the key request process.

FIG. 28 is a flow diagram of the send data package.

FIG. 29 is a flow diagram of the session end.

FIG. 30 is a flow diagram of the abort/error report.

FIG. 31 is a flow diagram of the close session.

FIG. 32 is a flow diagram of the send outbound request.

FIG. 33 is a flow diagram of the protocol package.

FIG. 34 is a flow diagram of an overview of the transaction flow.

FIG. 35 is an overview diagram of queue processing relationships.

FIG. 36 is a flow diagram of the transport protocol inbound.

FIG. 37 is a flow diagram of the transaction engine inbound.

FIG. 38 is a flow diagram of the transaction engine shell.

FIG. 39 is a flow diagram of the SDS inbound.

FIG. 40 is a flow diagram of the SDS outbound.

FIG. 41 is a flow diagram of the transaction engine outbound.

FIG. 42 is a flow diagram of the transport protocol outbound.

### DETAILED DESCRIPTION OF THE PREFERRED EMBODIMENTS

Several embodiments described herein relate to methods and apparatus for use in connection with the translation and use of electronic business data in one or more computer networks. As will be apparent, however, the methods and apparatus are equally applicable in connection with any suitable type of data and files.

In one embodiment, the system is composed of four modules. The first module is primary and is composed of activation functions. The second module consists of the sales function. It is further composed of the purchase, invoice, and authorization transactions. The third module is the shipping function. It is composed of shipping status and product return transactions. The fourth module is the accounts receivable function which is composed of payment authorization, sales on account, and account status transactions.

With respect to business information data that will be used, the present embodiment is a system which provides full e-commerce functionality from the trading partner's or third party's computer system to the client's back office, including software such as a specific accounting software application used by the client. With respect to the functionality, the system can function with a diverse variety of front office systems as well as a diverse number of back office systems.

The present invention provides the means for a group of data to be used by one or more applications which may not be otherwise compatible. A back office system is typically composed of one or more servers, and a suite of software applications that provide a backbone for the client's internal business operations. The commerce server's operating system would normally compliment the back office operating system, for example Windows 98 by Microsoft. Some examples of software application suites that would be found in the back office are People Soft, MYOB and Peachtree.

Various methods and systems for identifying business information data on a remotely-hosted database are also disclosed.

Broadly, one system method includes the steps of: (1) processing, at an originating computer, transaction data from an application suite; (2) generating standardized data transactions, based on earlier definitions of what that data should be; (3) sending, from the originating computer to a destination computer, the standardized transaction data; (4) receiving, at the destination computer, transaction data from the originating computer; (5) generating transaction data based on the attributes of the destination computer, and storing the transaction data in a file on the destination computer; and (6) processing, at the destination computer, transaction data from the data file into a target application suite.

The disclosed embodiments provide a means for users to manage their business and financial information in various servers over a computer network. In return, e-business companies such as Business-to-Consumer (B2C) companies are supplied the opportunity to provide services of value to their customers by having a more dynamic interface from the front office, for instance their web site, to the back office software application suites, and vice versa. In addition, computers are being used to automatically exchange data with other businesses as in a Business-to-Business (B2B) situation, and between geographically diverse offices within the same business, also known as a Business-to-Enterprise (B2E) situation. Computers and other intelligent devices are becoming required for the management and sharing of data, and the present invention takes advantage of the intelligence and flexibility of these devices to create better ways of managing, sorting, sharing, exchanging and interacting with various forms of data.

In a hypothetical situation, a client would approach a vendor selling a product and/or service, and request the same product and/or service. The vendor may then need to either install physical hardware or adapt existing hardware to accommodate the requirements of the present invention. For example, a client would typically have a network system with an application server such as an IBM Pentium III based system running the Microsoft Windows NT operating system. This application server would further have the client's business applications relating to financial, sales, account receivable, accounts payable, shipping software modules or packages. Examples of these software packages include the Peachtree Accounting software, the Intuit Quickbooks software package, and other legacy software systems.

Using the various software applications, the client starts the exchange of information leading to the completion of the intended business function. This business function would typically begin with an exchange of business information, which includes locations, contact names, product catalog, and monetary rates. The client would then send a “purchase order”, which describes the intent of the client to purchase a product and/or service from the vendor. The purchase order is followed by the “invoice”, which details the products and/or services being purchased and includes pricing, fees, costs, and accepted payment methods. The invoice is followed by the “payment authorization,” which identifies the payment method, accounting information and financial institution from which funds will be drawn. The vendor finalizes the business function when payment is received and the client's account has been balanced in the system.

More detailed description is provided, to teach one skilled in the art, how to make and use the best mode of the inventions. Phase I is the activation phase, where the invention is installed and configuration information is established, as it relates to the functionality of the present invention. Phase II is the processing phase, where the individual transactions which make up business conversations or exchanges, are handled.

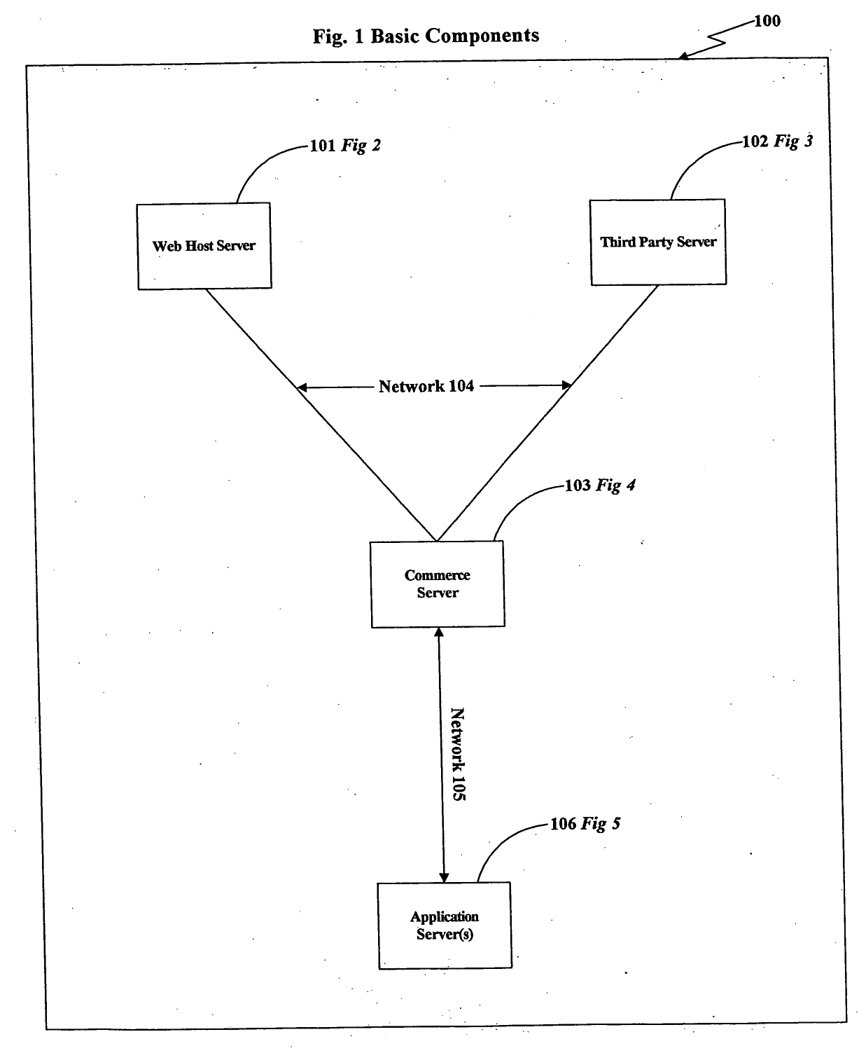

FIG. 1. shows a block diagram of a system 100 which includes a plurality of servers connected through one or more networks 104 and 105. As shown in FIG. 1, the computer system 100 includes a web host server 101, a third party server 102, a commerce server 103, and an application server 106. Each server shown in FIG. 1 may include a plurality of servers corresponding to the single server, all of which function within a system 100. For example, application server 106 may include one or more “control” servers and one or more “database” servers. If the Internet is utilized as one or more of network 104, web servers, which are not shown, may also be used as intermediary servers within network 104.

FIG. 1 further describes the interrelationship between the basic components used in activating, initializing and operating the present embodiment of the invention. The commerce server 103 is connected to the application server 106 via a network connection 105 which could also be any suitable direct connection. The commerce server 103 could also be co-located whereby equipment owned by a client can be located with other elements of the present invention in order to provide the best interconnection between devices. It is also possible that there could be more than one application server 106 as well as more than one commerce server 103. All servers in system 100 may be either local or remote in reference to the physical location of commerce server 103. In addition to user interaction through direct keyboard input and display output, each server in system 100 of FIG. 1 may allow the ability to start processes and direct resources from an appropriately connected, remote user workstation.

The present invention generates transactions that can function over any standard network to which the commerce server is connected, in this instance networks 104 and 105. Server 103 directs resources on Server 106 using RPC over network 105.

Examples of a typical network 104 or a typical network 105, with which the present invention could function, are a WAN (Wide area network), a communications network that covers a wide geographic area such as state or country, a LAN (local area network) or a network generally contained within a building or complex, or MAN (metropolitan area network), a network that generally covers a city or suburb. Further examples are a large network made up of a number of smaller networks, and the Internet, which is made up of many millions of computers in more than one hundred countries.

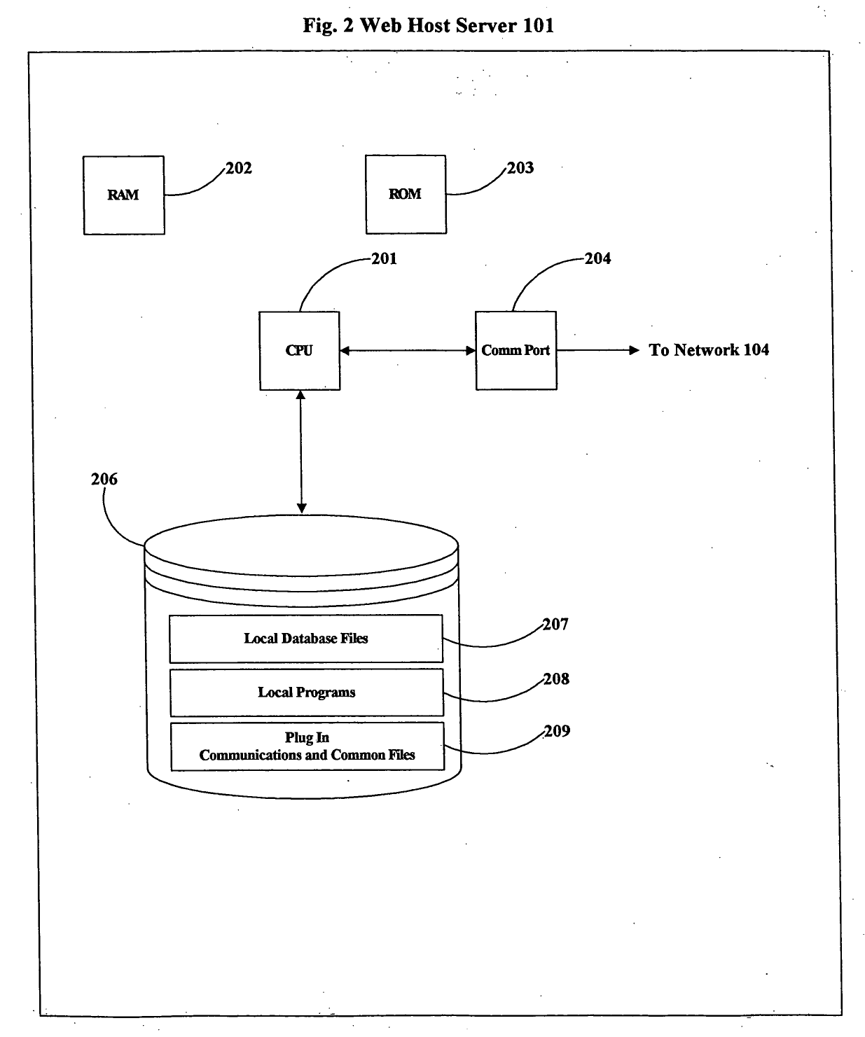

FIG. 2 is a diagram of the web host server 101 of FIG. 1, which may be representative of one or more other web host servers. Web host server 101 includes a central processing unit (CPU) 201, a random access memory (RAM) 202, a read only memory (ROM) 203, a communications port 204, and a data storage device 206. CPU 201 is coupled to communications port 204 so that a user can communicate over network 104. Although not shown, web host server 101 may also include various input/output (I/O) devices, such as a keyboard, mouse, visual display, and speakers for audio for the user. Web host server 101 also runs an operating system, which may be UNIX, Linux, or any other suitable operating system. Data storage device 206 may be a hard disk drive, CD-RW drive, FLASH array, or other mass storage device, and includes a local database files 207, local programs 208, and plug-in communications and common files 209.

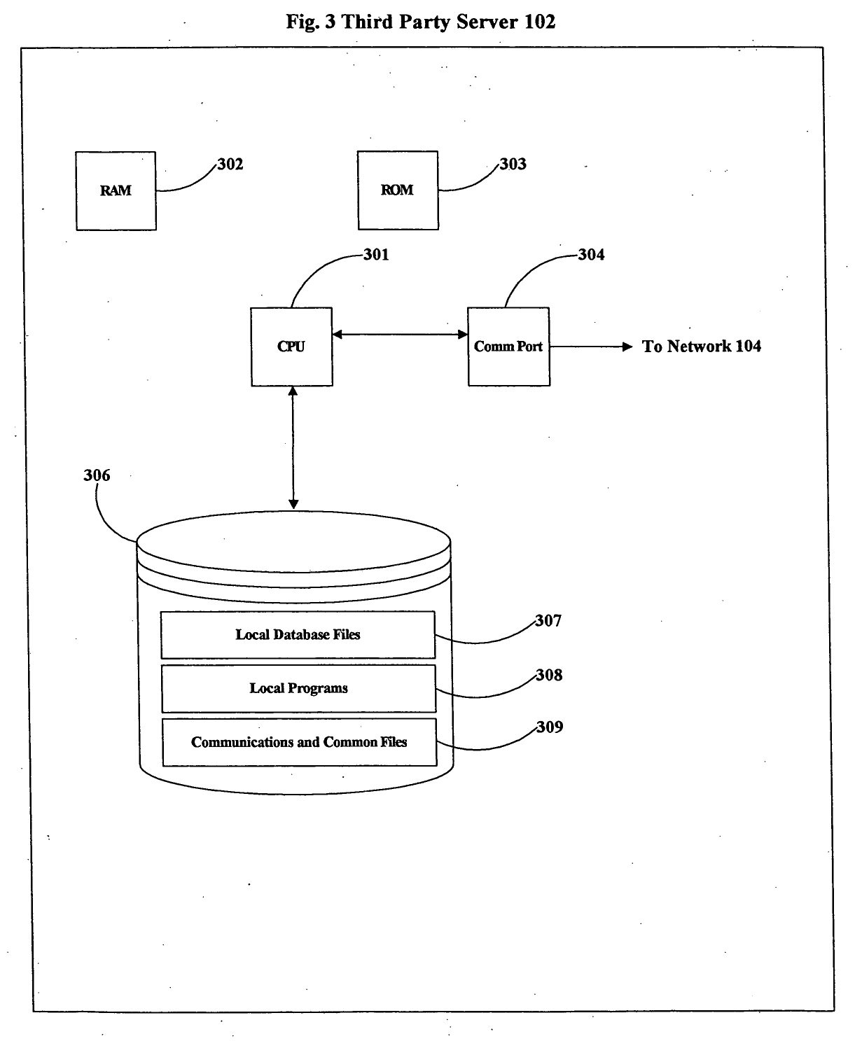

FIG. 3 is a diagram of a third party server 102 of FIG. 1, which may be representative of one or more other third party servers. Third party server 102 includes a central processing unit (CPU) 301, a read only memory (ROM) 303, a random access memory 302, a communications port 304, and a data storage device 306. CPU 301 is coupled to communications port 304 so that a third party server 102 can communicate over network 104. Although not shown, third party server 102 may also include various input/output (I/O) devices, such as a keyboard, mouse, visual display, and speakers for audio for the user. Third party server 102 also runs an operating system, which may be UNIX, Linux, or any other suitable operating system. Data storage device 306 may be a hard disk drive, CD-RW drive, FLASH array, or other mass storage device, and includes a local database files 307, local programs 308, and communications and common files 309. The communications and common files 309, would preferably consist of another fully installed and configured version of the present invention, but may consist of merely a compatible plug-in communications object and substantiating data.

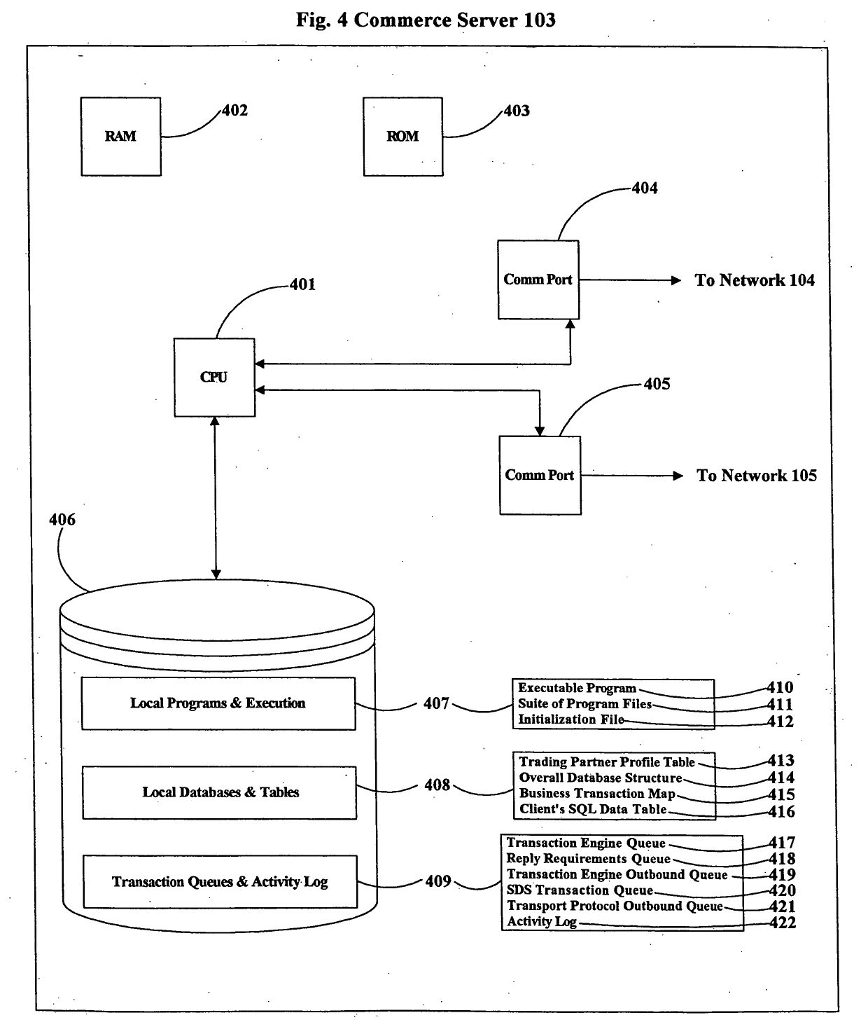

FIG. 4 is a diagram of a commerce server 103 of FIG. 1, which may be representative of one or more other commerce servers. Commerce server 103 includes a central processing unit (CPU) 401, a random access memory 402, a read only memory 403, a communications port 404, a communications port 405, and a data storage device 406. CPU 401 is coupled to communications port 404 so that commerce server 103 can communicate over network 104, and CPU 401 is coupled to communications port 405 so that commerce server 103 can communicate over network 105. Although not shown, commerce server 103 may also include various input/output (I/O) devices, such as a keyboard, mouse, visual display, and speakers for audio for the user. Commerce server 103 also runs an operating system, which may be Windows NT, Windows 98, or any other suitable operating system. Data storage device 406 may be a hard disk drive, CD-RW drive, FLASH array, or other mass storage device, and would preferably include local programs 407, local database files and tables 408, and transaction queues and logs 409.

Local programs 407 contains executable programs 410, a suite of program files 411, and an initialization file 412. Local database and tables 408 contains a trading partner profile table 413, an overall database structure 414, a business transaction map 415, and a client SQL data table 416. Transaction queues and activity log 409 contains a transaction engine queue 417, a reply requirements queue 418, a transaction engine outbound queue 419, a symbolic data stream (SDS) transaction queue 420, a transport protocol outbound queue 421, and an activity log 422.

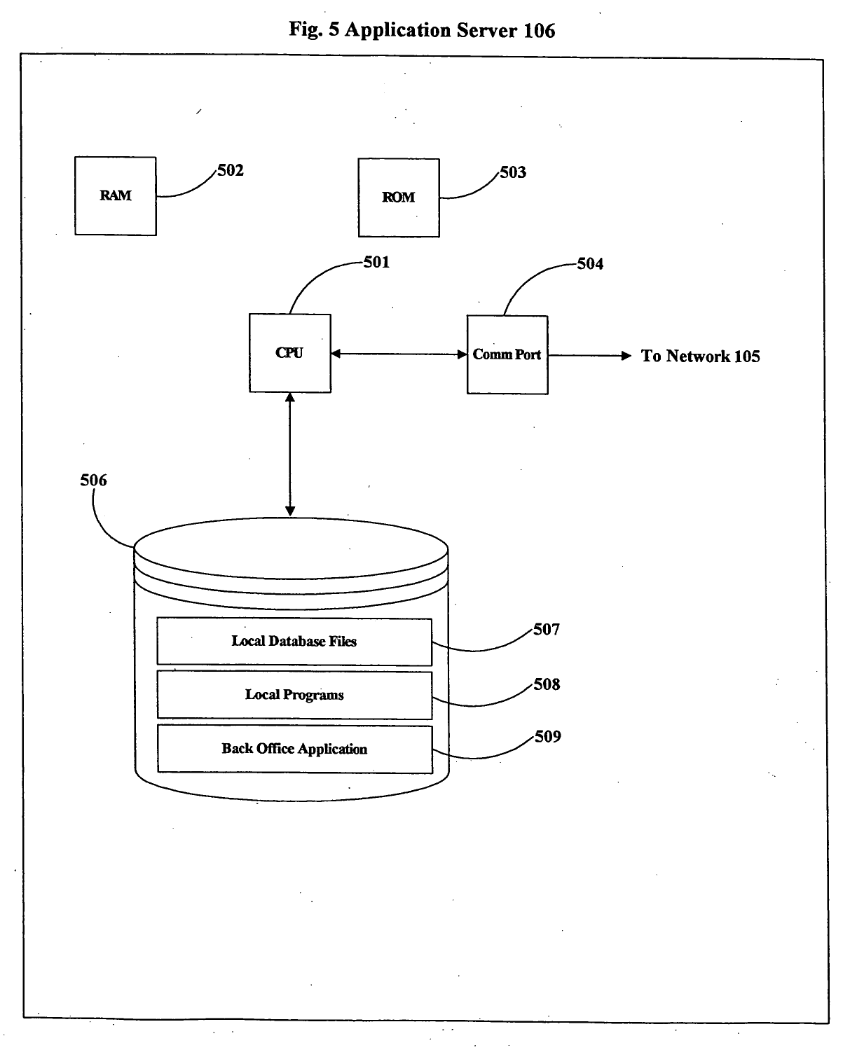

FIG. 5 is a diagram of an application server 106 of FIG. 1, which may be representative of one or more application servers. Application server 106 includes a central processing unit 501, a random access memory 502, a read only memory 503, a communications port 504, and a data storage device 506. CPU 501 is coupled to communications port 504 so that application server 106 can communicate over network 105. Although not shown, application server 101 may also include various input/output (I/O) devices, such as a keyboard, mouse, visual display, and speakers for audio for the user. Application server 101 also runs an operating system, which may be Windows NT, Windows 98, or any other suitable operating system. Data storage device 506 may be a hard disk drive, CD-RW drive, FLASH array, or other mass storage device, and would preferably include local database files 507, local programs 508, and back office application 509.

Generally, files that contain business transaction data may reside locally at commerce server 103 or remotely at application server 106. Typical examples of a business data file are an invoice form, a purchase order form, an account status form, and a payment remittance advice form.

Many embodiments described herein relate to data that are business information stored in digital files. It is noted that many terms herein such as data, records, tables, fields, characteristics, and user-determined characteristics should be construed in context of a technical application, such as in a computer software application, and should not be read as the same as any mental or “paper & pencil” type objects. The fields, separately or together (depending on the design and file) uniquely identify the data within local databases and tables 408.

One of the tables is the trading partner profile table 413, which is the defining information for both the client and the customer network locations as well as the client and customer formal business structures. Examples of fields include profile name, Internet Protocol (IP) address, allowed transactions, and transaction format. Examples of transaction formats are EDI, XML and EDIFACT.

Another table found in the local databases and tables 408 is the overall database structure 414, which contains the defining information for the source of all the data in the commerce server 103, including information as to how the data is accessed by other servers, and information on where the data is used. Examples of fields in the overall database structure 414 include field name, source, access method, allowable values, data types, data sizes, and whether the field is required or optional.

Another table found in the local databases and tables 408 is the business transaction map 415, which contains the defining information for managing the transaction flow and individual transactions in system 100, depending on the type of interface required of the commerce server 103. A map of the specific transactions, as required for communication with the back office, is maintained. Examples of fields in the business transaction map 415 include transaction identifier, additional business conversation transactions, and business transaction standards. An example of a business transaction standard could be a requirement that there be a three day hold on shipping for any credit card purchases completed within system 100.

Another table in the local databases and tables 408 is the client SQL data table 416, which is the source of information for the populating of data in outbound transactions, and the source of verification information for inbound transactions. Table 416 may contain one or more types of data including customer data, accounting data, shipping data, and product data.

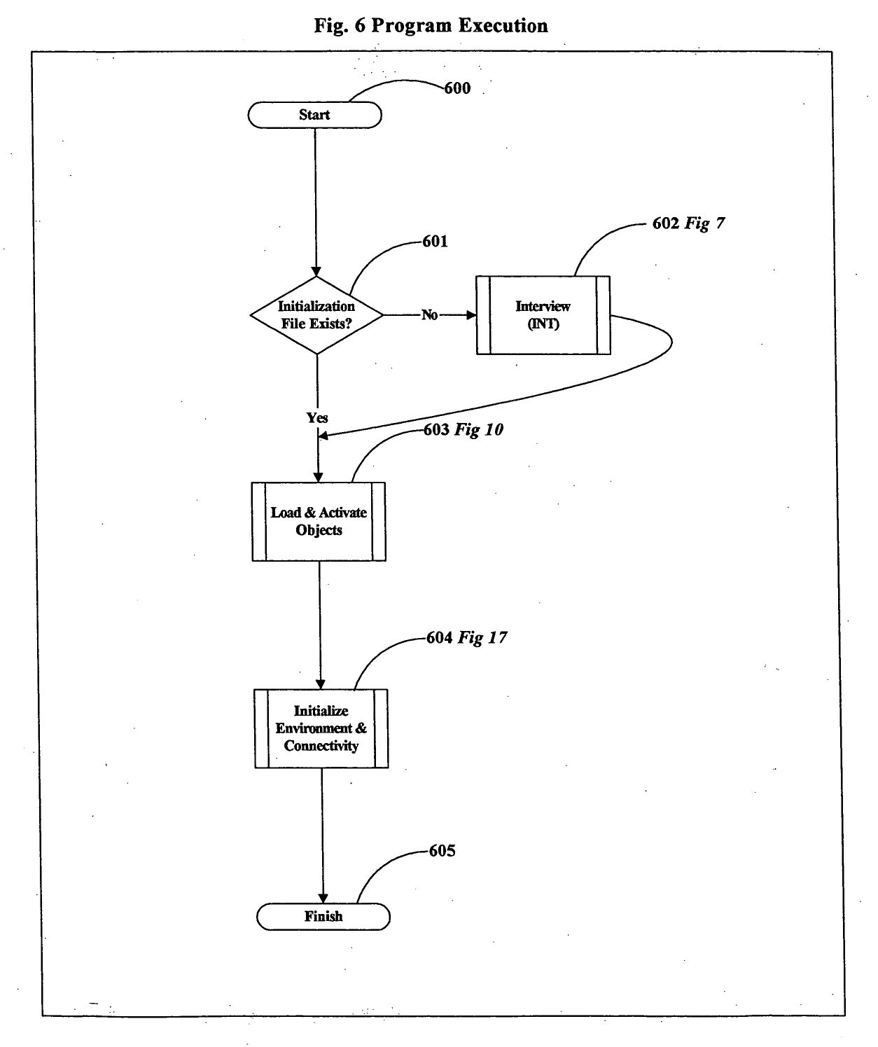

FIG. 6 shows an overview of the activation of the method, system and apparatus of system 100. Preferably, step 601 is performed, according to a previously established configuration, to independently act after some initial setup which is not shown, where it may execute periodically, as in the application of electrical power to the commerce server 103 as shown in FIG. 1. On the other hand, step 601 may be performed in response to a user input at commerce server 103 (or any suitable workstation connected to network 105), such as a selection to “run” an executable software file, for example startup.exe.

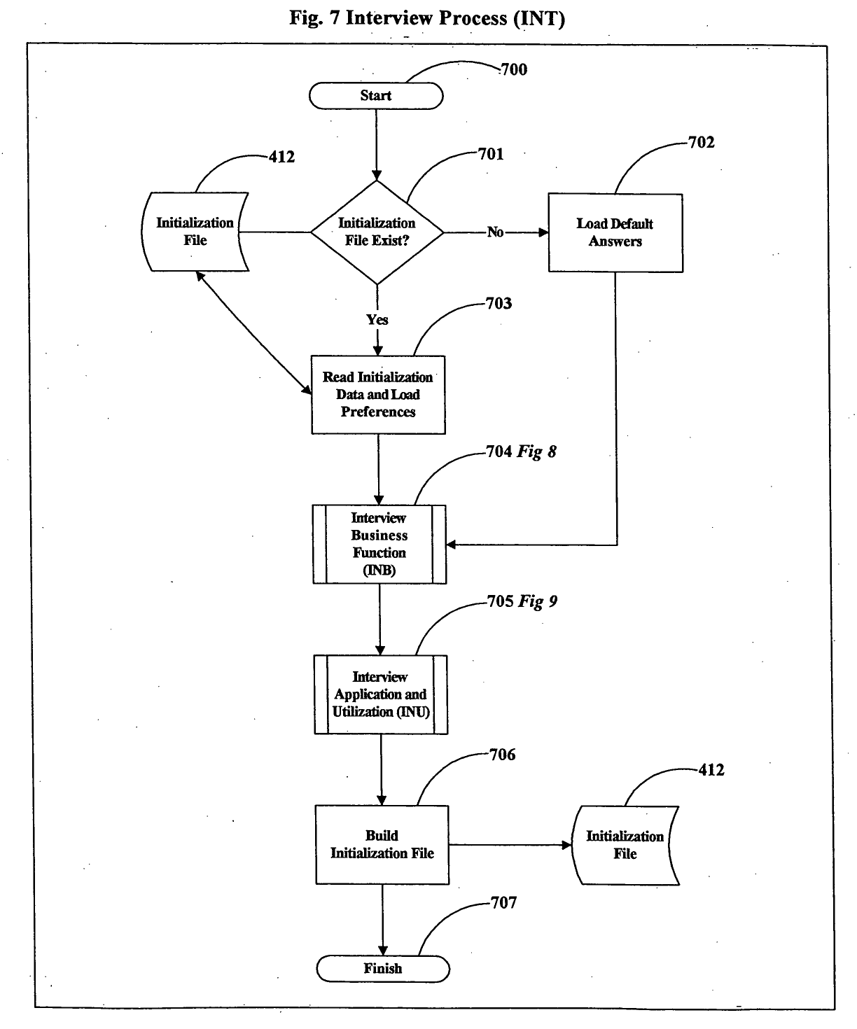

Beginning at start block 600 of FIG. 6, step 601 determines the existence of the initialization file 412. Step 601 asks the operating system of the commerce server 103, through the use of a “system call”, if the file is physically present at a predetermined location on the storage medium 406 of commerce server 103, by reading a descriptive file header contained in the file, or by other means. If step 601 determines the local file 412 is not present on server 103, step 602 initiates and enables the interview process as further shown in FIG. 7.

FIG. 7 is a flow diagram of an overview of the interview process. Beginning at start block 700 of FIG. 7, step 701 checks again if initialization file 412 exists in local programs and execution 407. It is necessary for this step to check again as the interview process of FIG. 7 may have been initiated from another process, and in such a case, it would be necessary to perform step 703 to populate initialization file 412.

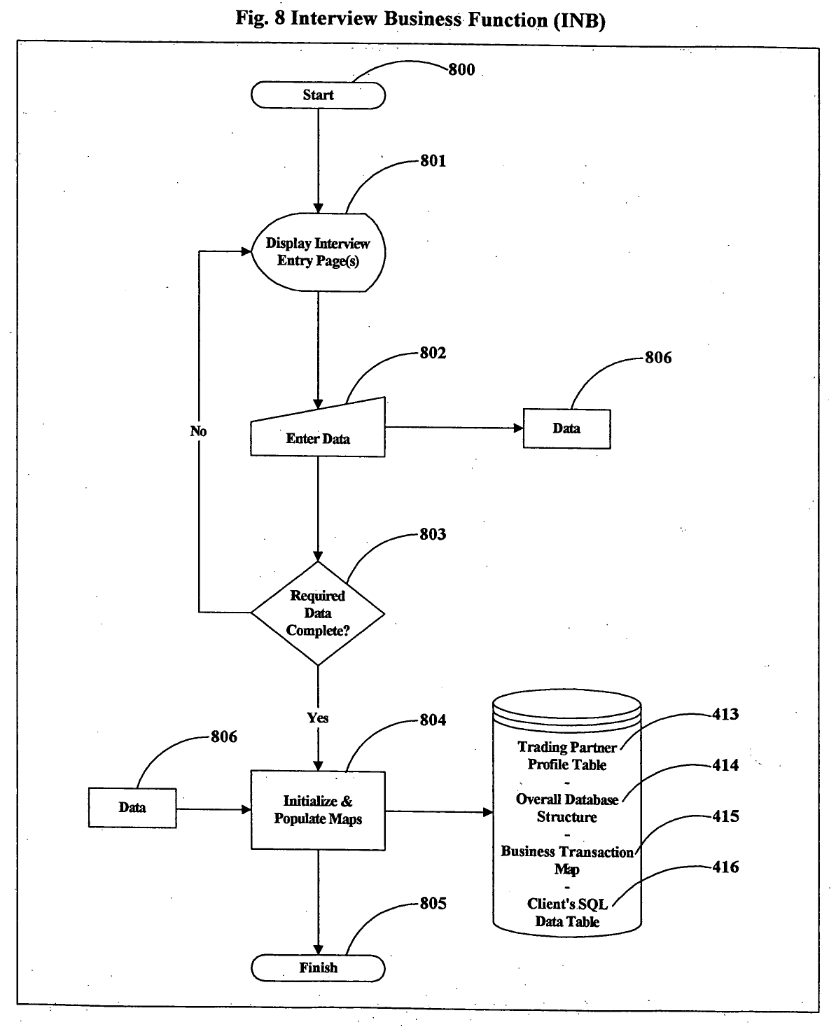

If step 701 determines the initialization file 412 is not present, step 702 loads predetermined default values to the entry screen on commerce server 103 and initiates step 704, which is shown more fully in FIG. 8.

FIG. 8 is a flow diagram showing an overview of the Interview Business Function. Beginning at start block 800 of FIG. 8, step 801 displays one or more interview entry forms at commerce server 103. In step 802, the user answers one or more questions in associated fields to which the user at server 103 would respond and input data 806 as appropriate. Examples of data or identifiers comprising data 806, which would be input by the user at server 103, include: whether or not the client uses a web site, the client's business name and address, the client's type of business, the identity of the client's back office software being used, and other data preferably contained in the EDI838 transaction. Step 803 determines if the required data 806 is complete, and if not, control returns to step 801. This process is repeated until either the user cancels and ends the entire process or the required data is deemed complete by step 803. Once step 803 is complete, data 806 is used in step 804 to populate the trading partner profile table 413, the overall database structure 414, the business transaction map 415, and the client's SQL data table 416. Once step 804 is completed, finish block 805 is reached and step 704 of FIG. 7 is complete.

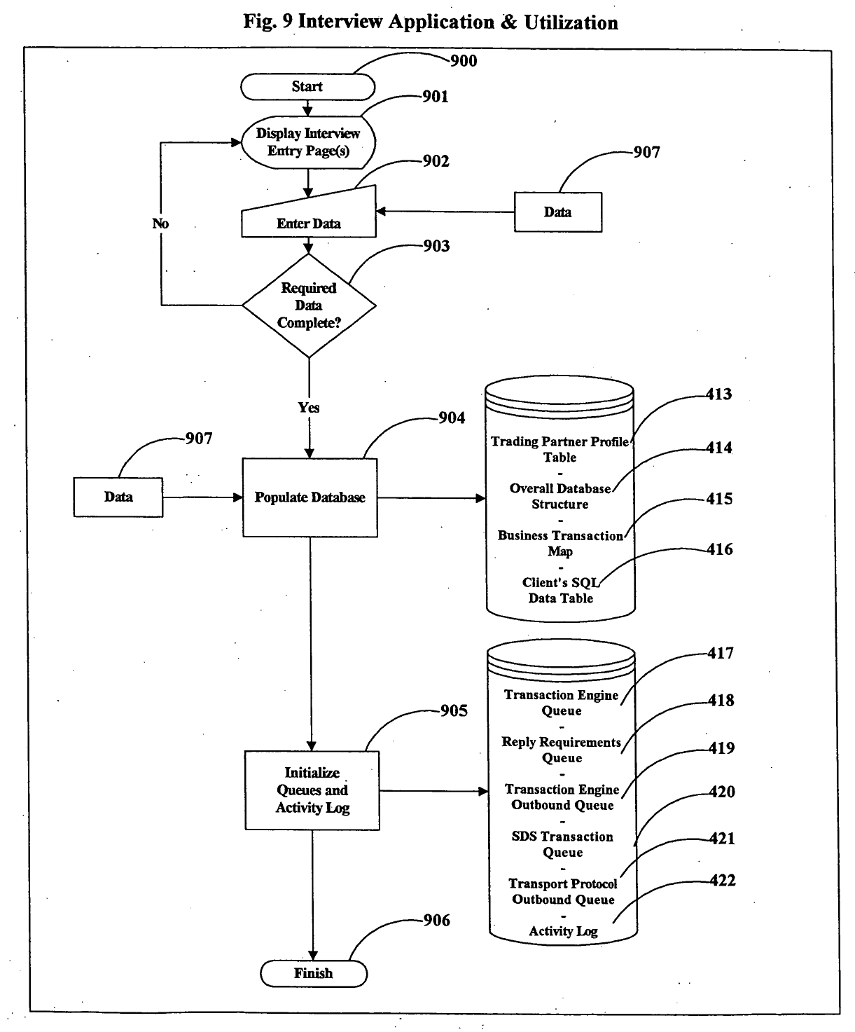

Next, step 705 of FIG. 7, further shown in FIG. 9, interviews the user for application and utilization information. Beginning at start block 900 of FIG. 9, step 901 displays one or more interview entry screens at commerce server 103. In step 902, the user answers one or more questions in associated fields to which the user would respond and input data 907 as appropriate. Examples of data 907 include: accepted and used EDI transactions, specific data elements to be used, allowable values, and other data such as is contained in the EDI868. Step 903 determines if the required data is complete and if not, control returns to step 901. This process is repeated until either the user cancels and ends the entire process or the required data is deemed complete by step 903. Once the data 907 is deemed complete by step 903, step 904 uses data 907 to populate the trading partner profile table 413, the overall database structure 414, the business transaction map 415 and the client's SQL data table 416.

Once step 904 is complete, step 905 initializes the queues and activity log so that they are in a clean, ready to use condition. Once step 905 is complete, finish block 906 is reached and step 705 of FIG. 7 is complete. The next step in FIG. 7, step 706, saves all initialization data to initialization file 412. Once step 706 is completed, finish block 707 is reached and step 602 of FIG. 6 is completed.

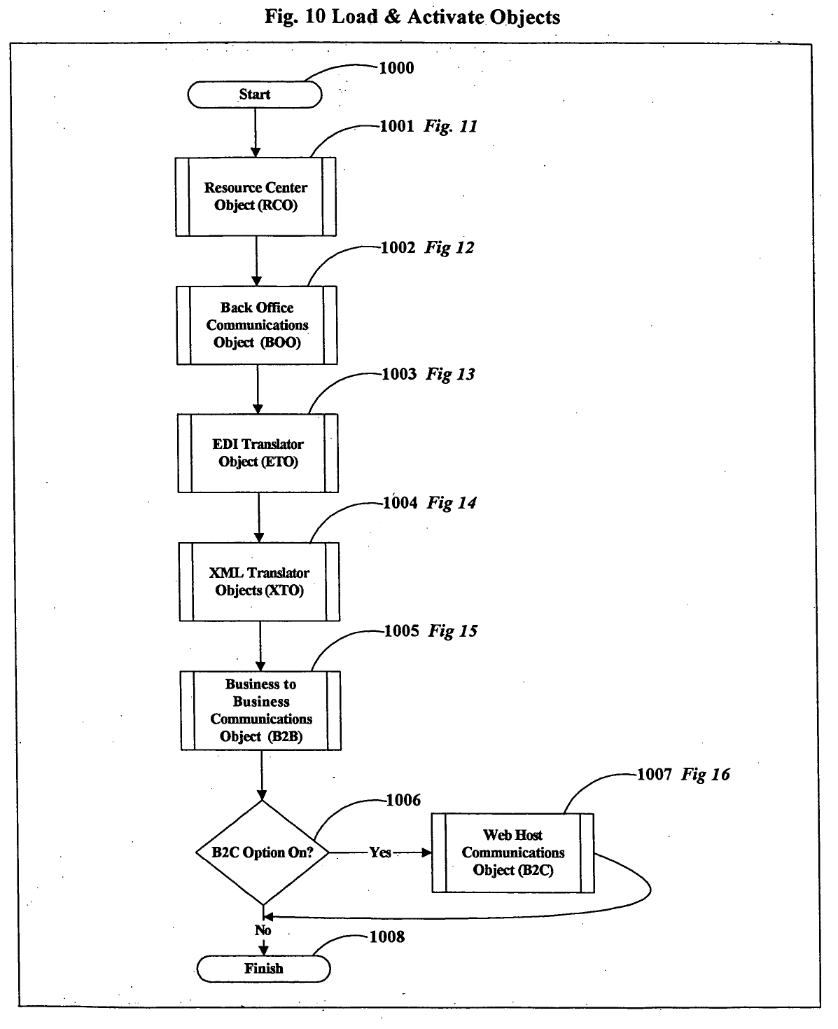

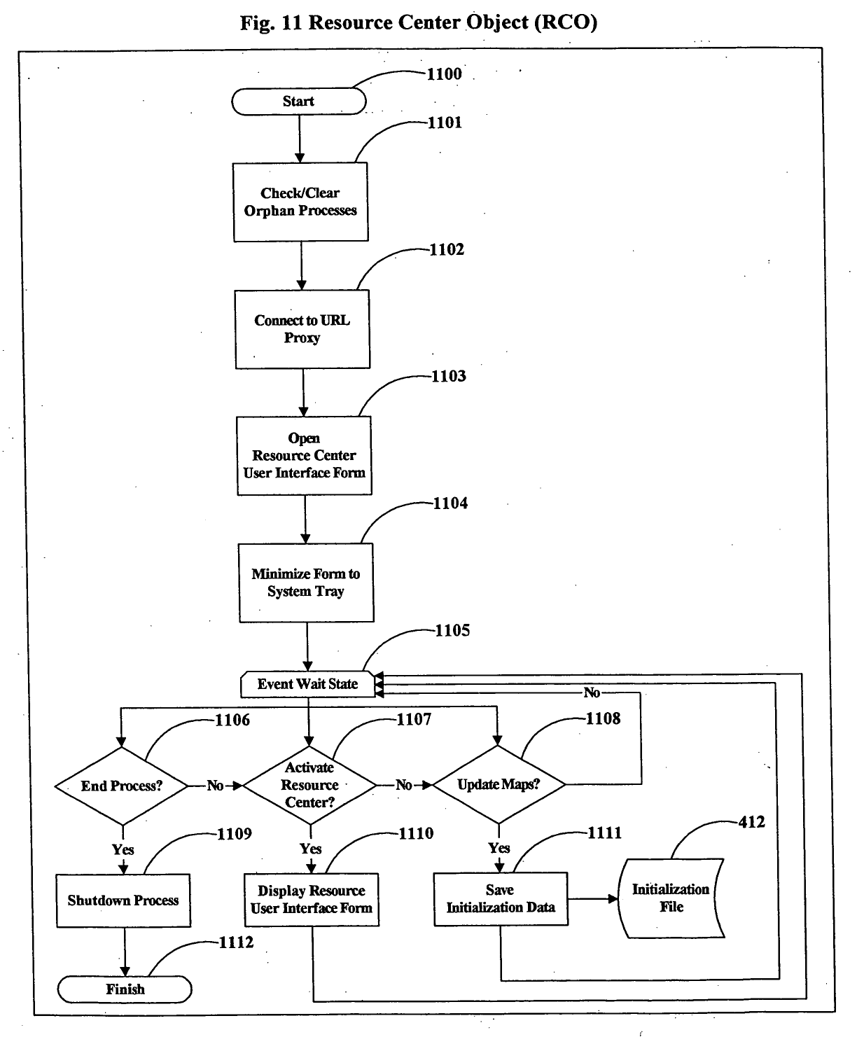

Step 603 of FIG. 6, shown more fully in FIG. 10, then loads and activates objects. FIG. 10 is an overview diagram of the loading and activation of objects. Although FIG. 10 shows a flow diagram in a linear fashion, steps 1001 through 1006 run concurrently, and are not dependent on each other. Beginning with step 1001, the resource center object is loaded and activated. Step 1001, the Resource Center Object, is shown more fully in FIG. 11. From start block 1100 in FIG. 11, step 1101 checks and clears any orphan processes by enumerating the task list of commerce server 103, searching for running objects and requesting the commerce server 103 operating system to halt any such processes. Next, step 1102 connects to the registered URL proxy in order to obtain the TCP/IP port assignment and verify connectivity. Step 1103 loads the user interface form in display memory at commerce server 103 and hides the form. Step 1104 loads the program's icon to the system tray if the operating system of commerce server 103 allows this function. Once steps 1101 through 1104 complete, step 1105 places the resource center into an event wait state.

In the event wait state, the resource center object waits for one of three menu events to occur. In one situation, the activate resource center event 1107 opens the user interface form (step 1110) allowing the user at commerce server 103 to effect changes in the initialization and configuration data contained in initialization file 412. In a second situation, the update maps event 1108 allows the user at commerce server 103 to save the initialization data (step 1111) to the initialization file 412. The activate resource center and update maps events result in returning to the event wait state. The end process event (step 1106) allows the user at commerce server 103 to shut down the entire application (step 1109) ending the process at finish block 1112.

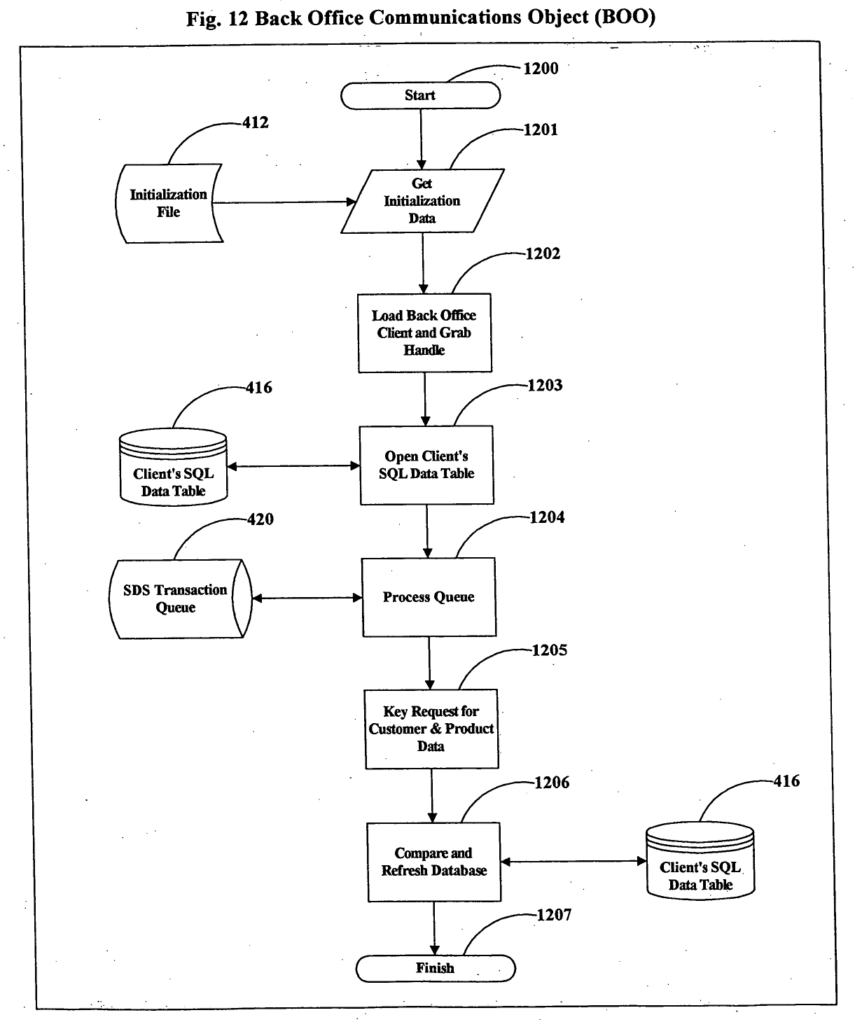

Once the resource center establishes the event wait state in step 1105, step 1002 of FIG. 10, further shown in FIG. 12, loads and activates the back office communications object. Beginning at start block 1200, initialization data 412 is retrieved (step 1201). Next, in step 1202, the back office client is started and the process handle is stored in active memory for future use. Step 1203, using data from the client SQL data table 416, ensures that the local database files 507 of the application server 106 are the preferred environment.

Next, step 1204 processes transactions in transit from the SDS transaction queue 420. A request is made of the back office application 509 for customer and product data in local database files 507 (step 1205). Lastly, step 1206 uses the requested data to compare with, and modify if necessary, existing client SQL data table 416 before ending at finish block 1207. Step 1002 of FIG. 10 is also now completed.

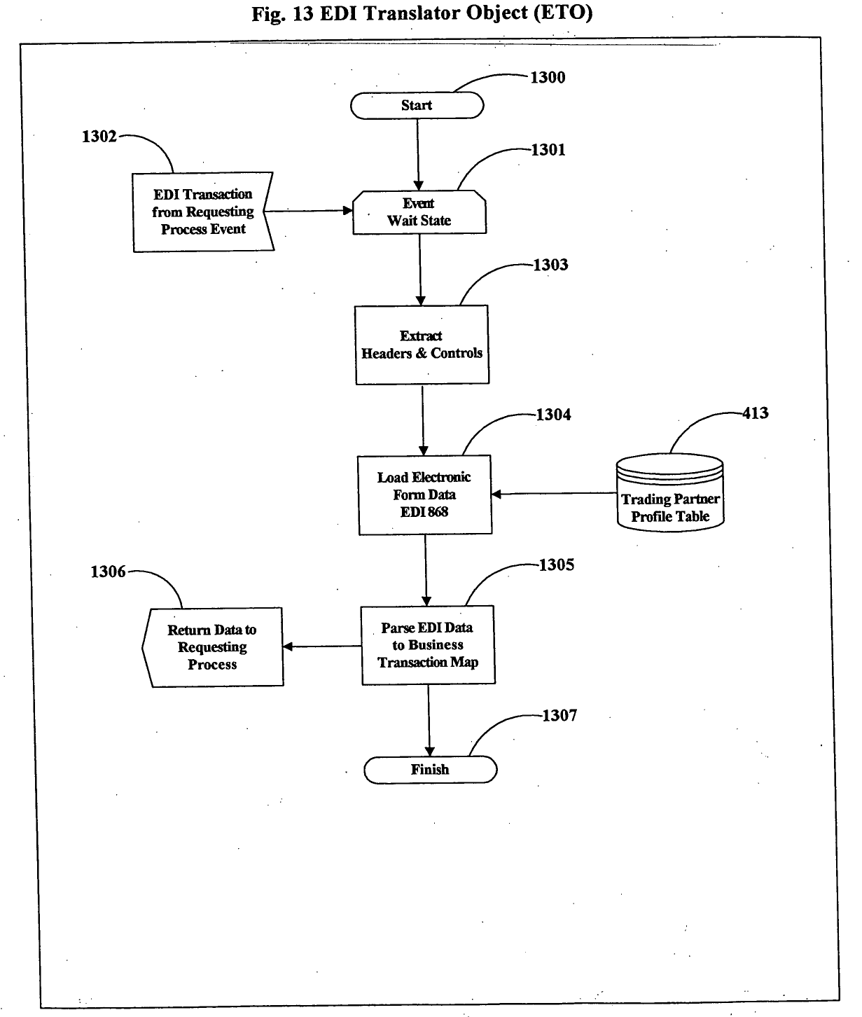

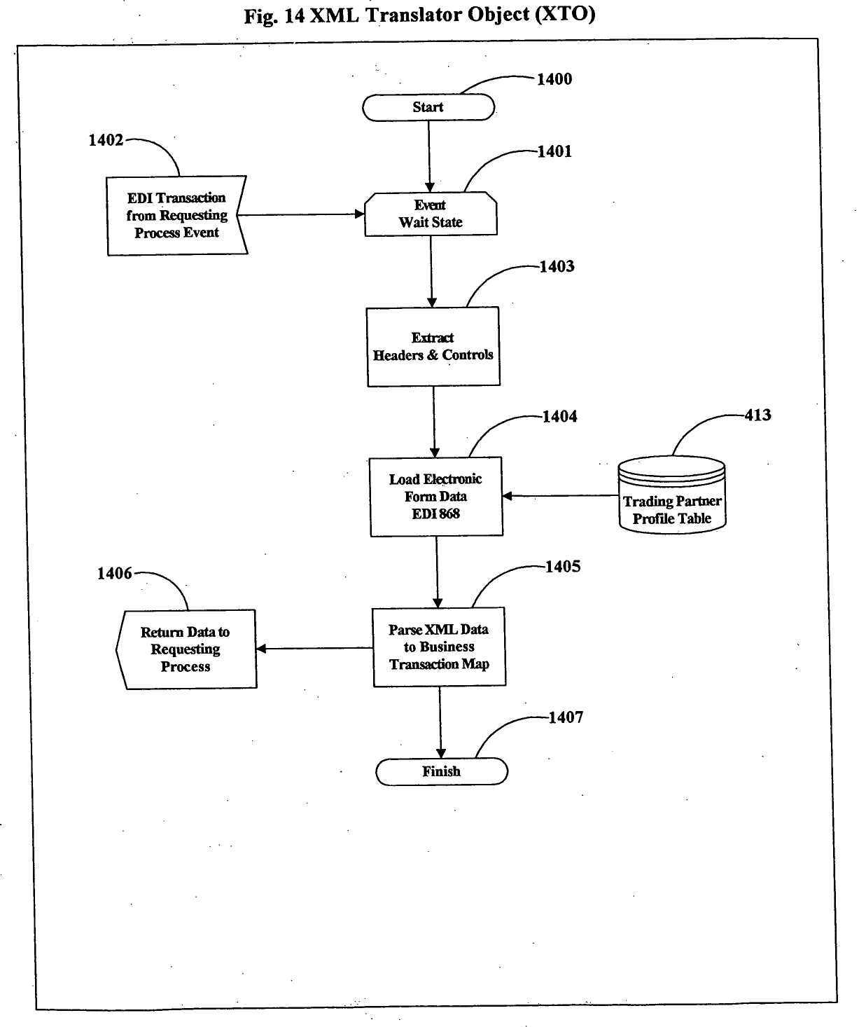

The EDI translator object is next started in step 1003. Step 1003 is further shown in FIG. 13. Beginning at start block 1300, the EDI translator object assumes an event wait state (step 1301). Step 1302 occurs when an event requests translation service from this translator object, preferably a request from another process to translate EDI data. Once the event 1302 is triggered, the event wait state ends and step 1303 extracts the header information to be used in parsing the data in the request. Step 1304 loads electronic form data preferably from the EDI standard transaction, EDI868, which allows the translator to build a data structure to hold the information contained in the request. Step 1305 extracts the data from the request, builds the EDI data structure and returns the extracted data to the requesting process 1306. The process ends at finish block 1307, which also completes step 1003 of FIG. 10. The XML translator is then started in step 1004, which is further shown in FIG. 14.

FIG. 14 is a diagram of the loading and activation of the XML translator object. Beginning at start block 1400 of FIG. 14, the XML translator object assumes an event wait state 1401. Events in step 1402 occur from other processes requesting translation service from this translator object. Once an event triggers step 1402, step 1403 extracts the header information from the request for use in parsing the data in the request. Step 1404 loads parsing information from the XML header which allows the translator to build a data structure to hold the information contained in the request. Step 1405 extracts the data from the request, builds the XML data structure and returns the extracted data to the requesting process 1406. The process ends at finish block 1407, which also completes step 1004 of FIG. 10.

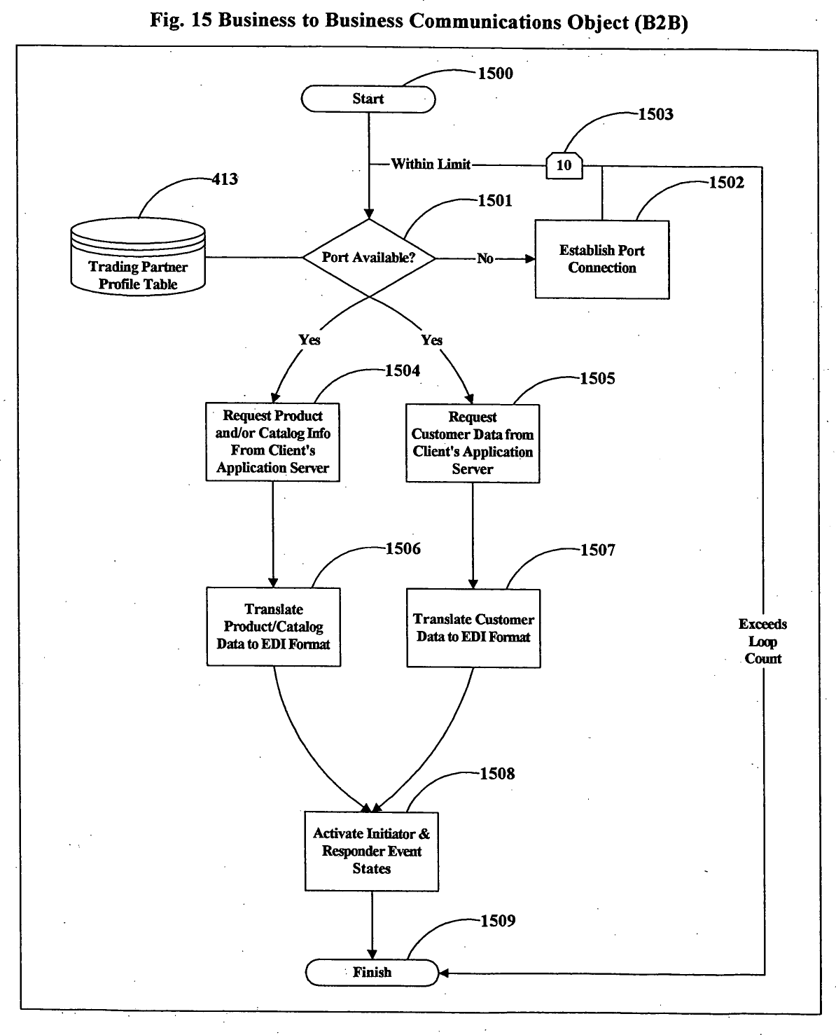

Next, step 1005 of FIG. 10 initializes the business to business (B2B) communications object. Step 1005 is further shown in FIG. 15. Beginning at start block 1500, the B2B object first determines if there is an existing port connection available (step 1501). If an assigned port is not available, step 1502 requests a new port connection while it keeps track of the number of times a port connection is requested. Step 1503 determines if too many requests have been made, preferably ten or more times, and if so, communications are not established and finish block 1509 is reached.

If the request count is not exceeded in step 1503, processing continues at step 1501 to again determine if an assigned port is available. Once step 1501 determines the assigned port is available, steps 1504 and 1505 are initiated concurrently.

Step 1504 requests product and/or catalog information from back office application 509, and step 1506 translates data preferably to EDI format. Step 1505 requests customer and other related information from back office application 509 and step 1507 translates the data preferably into EDI format.

In finalizing the parallel processing of steps 1506 and 1507, step 1508 activates the initiator and responder event states, and it sets an environment variable which indicates that inbound and outbound business to business transactions are allowed to occur. Once step 1508 is complete, finish block 1509 is reached, step 1005 in FIG. 10 is completed, and B2B connectivity is established.

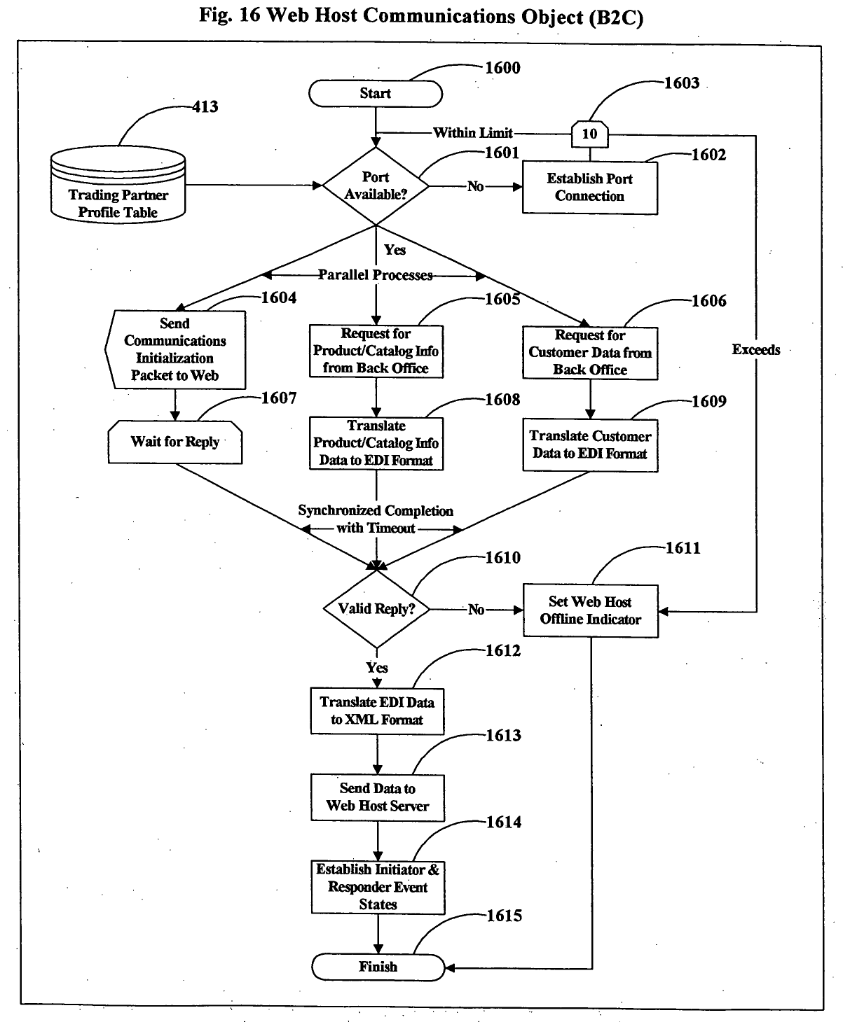

Next, step 1006 of FIG. 10, using data from initialization file 412, determines if the business to consumer (B2C) communications object is to be initialized, and if it is to be initialized, step 1007 starts the web host communications object, which is further shown in FIG. 16.

Beginning at start block 1600 of FIG. 16, step 1601 determines if there is an existing port connection available. If there is no existing port connection assigned, step 1602 requests a new port connection while counting the number of times a port connection is requested. Step 1603 determines if the request count has exceeded a preset limit. If the request count is exceeded, step 1611 then sets a flag indicating that the web host is offline, no communications are established, and finish block 1615 is reached.

If the request count is not exceeded in step 1603, processing continues at block step 1601 to again determine if a port is available. Once step 1601 determines that a port has been assigned, the next steps, step 1604, step 1605, and step 1606 are processed concurrently.

Step 1604 sends a communications initialization packet, which is not shown, to the web host server 101, and step 1607 waits for an reply. Step 1605 requests product and/or catalog information from the back office application 509, and step 1608 translates the data from step 1605 preferably to EDI format. Step 1606 requests customer and other related information from the back office application 509, and step 1609 translates the data from step 1606 preferably to EDI format.

Once steps 1607, 1608 and 1609 complete with timeouts, if necessary to synchronize completion, step 1610 determines if the web site server 101 has sent a valid reply. If the reply is determined to be invalid, or no reply is received, step 1611 sets a flag to indicate the web host server 101 is offline, and the process ends at finish block 1615. If step 1610 determines that the web host server reply is valid, step 1612, using data from table 414, translates the data formatted in steps 1608 and 1609 to a format suitable for the web host server 101, preferably XML. The translated data is then sent in step 1613 to the web host server 101.

Step 1614 establishes the initiator and responder event states, which allow the processing of inbound and outbound business to consumer transactions. The process ends at finish block 1615 and step 1007 of FIG. 10 is simultaneously completed.

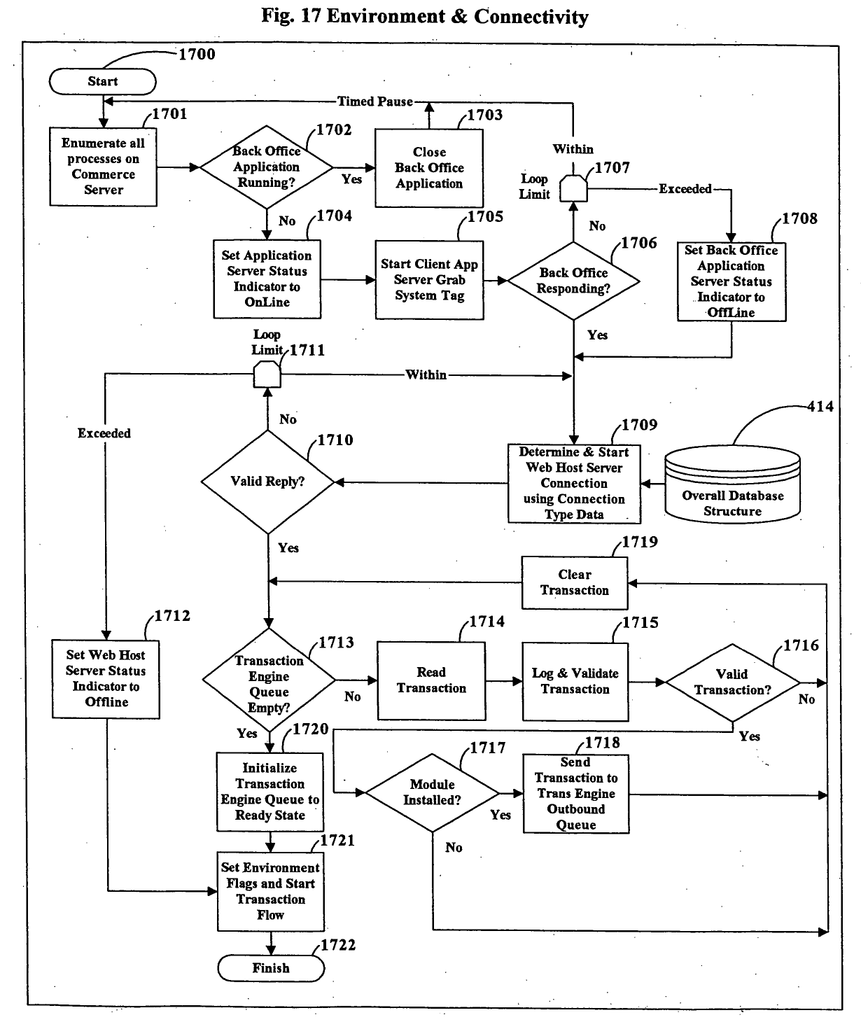

Finish block 1008 of FIG. 10 is reached and step 603 of FIG. 6 is also completed. Next, step 604 of FIG. 6, as further shown in FIG. 17, initializes the environment and the connectivity. Beginning at start block 1700, step 1701 enumerates the processing list of commerce server 103, where all processes currently running are placed in a list and given reference numbers. Step 1702 then checks the process list to determine whether the back office application 509 process is present. If step 1702 finds that the process is present, step 1703 sends a request using the reference number to close the process and control returns to step 1701.

If step 1702 determines the back office application 509 process is not running control continues to step 1704. Step 1704 sets a status flag indicating that the application server 106 is online. Step 1707 keeps count of the number of times step 1706 is reached, and then starts the back office application 509. Step 1705 grabs the process ID (PID) number assigned by the operating system.

Step 1706 then ensures that the back office application 509 is responding. If the back office application 509 response is confirmed, control continues to step 1709. Otherwise, step 1707 determines whether the count limit, being counted from step 1706, has been exceeded. If the limit in step 1707 is determined to be exceeded, step 1708 sets a flag indicating the back office application is offline and control continues to step 1709. If the limit in step 1707 is determined not to be exceeded, control returns to step 1701.

Step 1709, using data from overall database structure 414, if present, sets the web host server flag to on-line and establishes the network connection to the web host server 101, which results in either a valid reply from the web host server 101, a timeout resulting in no reply, or a determination that the connection is not applicable, as in the case where a client is not using the web host server 101 option.

Step 1710 validates the reply from the web host server 101. If step 1710 detects a timeout or invalid reply, then step 1711 determines whether the request count has exceeded a preset limit, preferably ten. If the limit is not exceeded, control continues to step 1709. Otherwise, step 1712 sets a flag indicating the web host server is offline and control continues to step 1721.

If step 1710 determines the reply from web host server 101 is valid, step 1713 checks the transaction engine queue 417 to determine if there is a transaction destined for the web host server 101 waiting to be processed. If there is a such a transaction waiting to be processed, step 1714 reads that transaction.

Step 1715 writes the transaction to the activity log 422 and checks the data for required elements and values. Step 1716 determines if the transaction is valid. If the transaction in step 1716 is not valid, step 1719 clears the transaction from the transaction engine queue 417 and control resumes at step 1713.

If the transaction in step 1716 is determined to be valid, step 1717 checks the installed modules in executable program 410 for the presence of the correct module. Step 1717 performs this check in order to determine if the executable program 410 is capable of processing the transaction. If step 1717 finds an acceptable module installed, step 1718 sends the transaction to the transaction engine outbound queue 419 resulting in a valid outbound transaction. Step 1719 then clears the transaction from the transaction engine queue 417 and control resumes at step 1713.

If step 1717 determines that the executable program 410 does not have the necessary module to process the transaction, step 1719 clears the transaction from the transaction engine queue 417 and control resumes at step 1713.

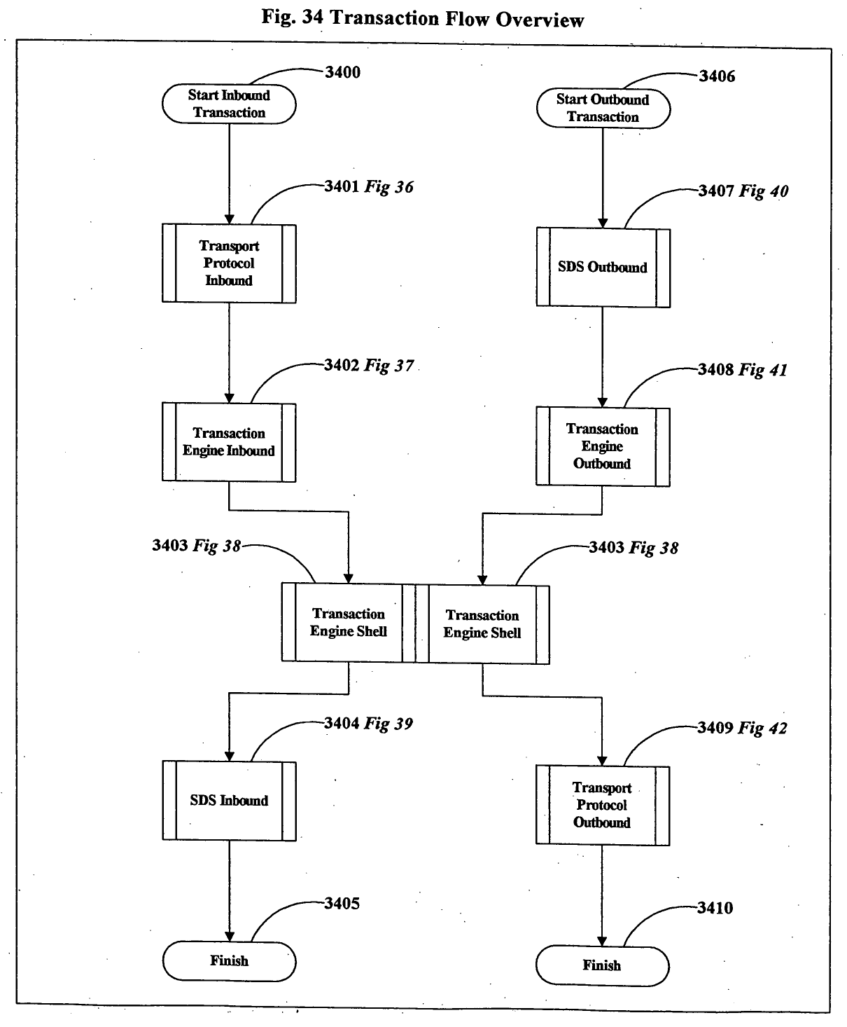

Once step 1713 determines that there are no more transactions to be processed from the transaction engine queue 417, step 1720 initializes queue 417 to a ready state. Step 1721 then sets the environment flags and starts the transaction flow, as further shown in FIG. 34. Once step 1721 is complete, finish block 1722 is reached, step 604 of FIG. 6 is completed, and finish block 605 of FIG. 6 is reached.

Currently, the exchange of information between trading partners uses the available methods of transport, such as SMTP, FTP and IP. These methods incorporate a third party server, of the type specific to the method, to act as the facilitator of the exchange. For example, when using SMTP, Simple Mail Transport Protocol, to send information to a trading partner, the data resides for a period of time on a SMTP server. This result of multiple copies of data residing on various servers subjects the information to possible theft or unwanted disclosure. The present invention incorporates a method of transporting information to trading partners without using these conventional protocols. This method includes a point-to-point, secure transfer protocol, which sends the information directly to the intended responder using high level encryption. It precludes the use of third party servers and as a result, avoids their inherent flaws.

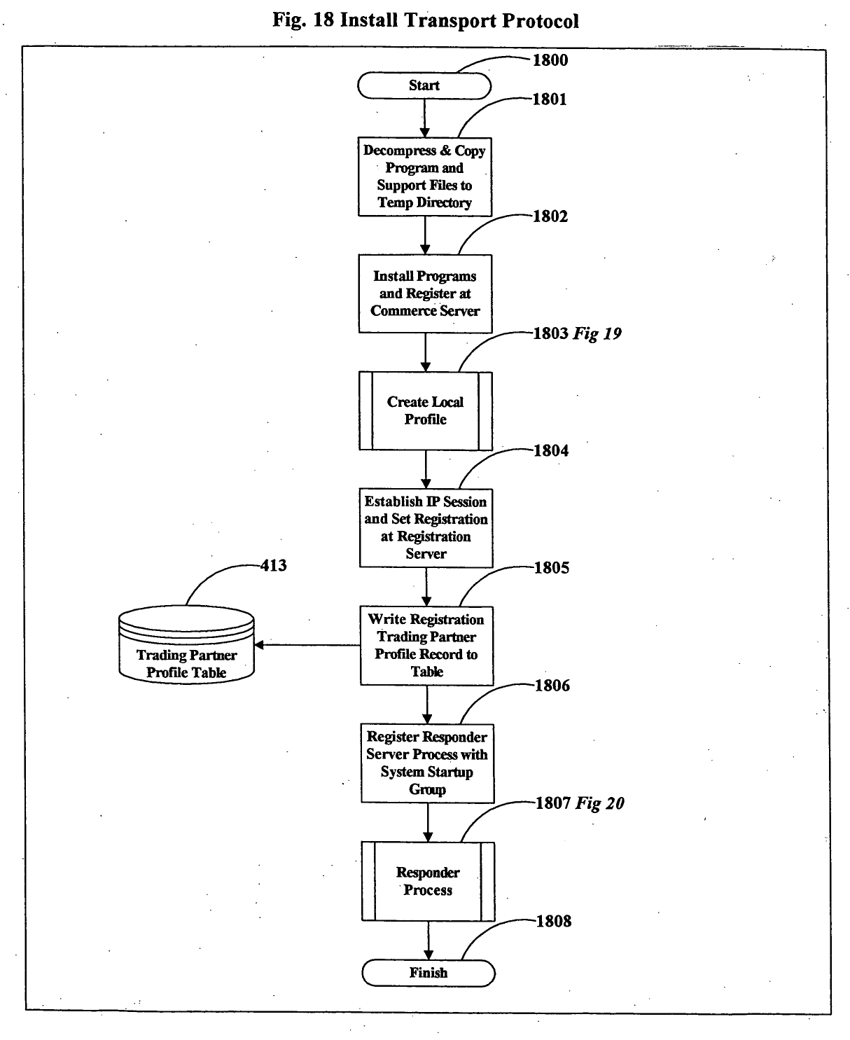

FIG. 18 is a flow diagram of the installation of the transport protocol. Preferably, step 1801 is performed in response to input at commerce server 103, wherein the user directs the transport protocol to be installed on commerce server 103. Beginning at start block 1800 of FIG. 18, step 1801 first decompresses the program and supporting files, and it then copies those files to a temporary location on commerce server 103. Step 1802 then installs the program and files to the install location and registers the program with the operating system of commerce server 103.

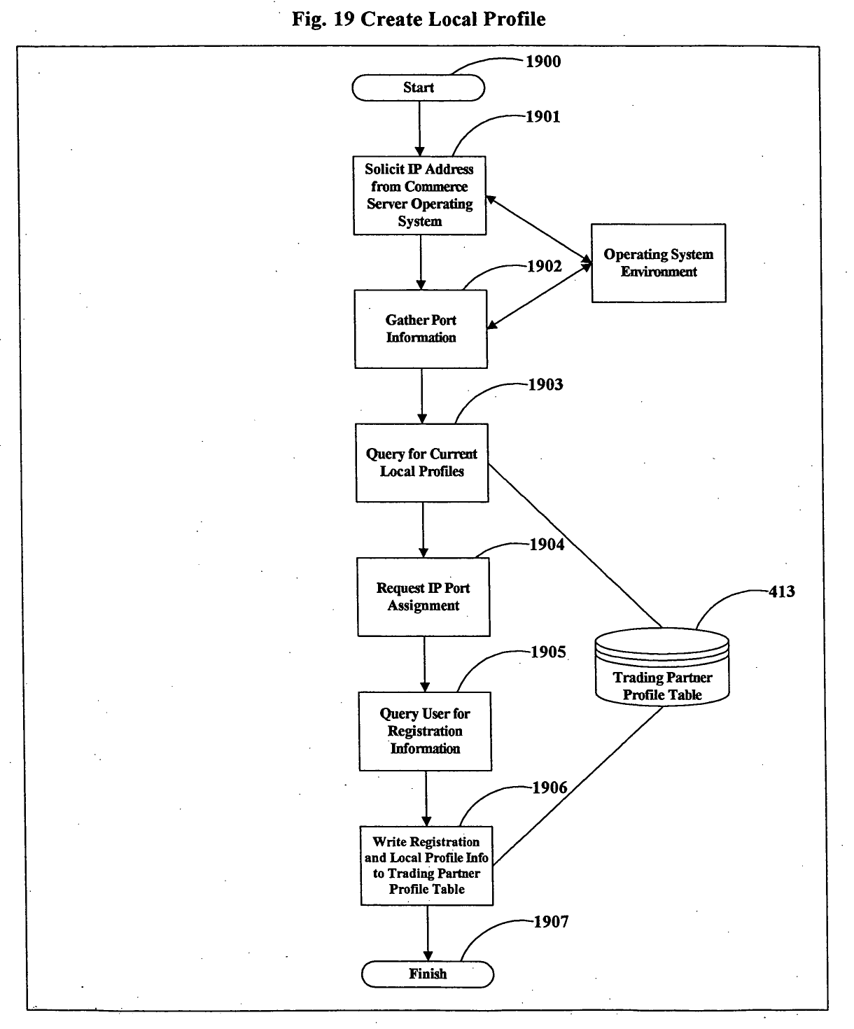

Step 1803 creates the local profile record in the trading partner profile table 413, as further shown in FIG. 19. FIG. 19 is a flow diagram of the create local profile function. Beginning at start block 1900 of FIG. 19, step 1901 solicits the local IP address from the operating system of commerce server 103. Step 1902 then gathers information about the IP port settings. Step 1903 next checks the trading partner profile table 413 for any existing local profiles. Step 1904 requests an IP port assignment from the operating system, and step 1905 queries the user for registration information, such as name, e-mail address and registration number. Step 1906 then writes the registration and local profile information to the trading partner profile table 413. Once step 1906 is complete, finish block 1907 is reached and step 1803 of FIG. 18 is complete.

Next, step 1804 establishes a communications session with a registration server, which is not shown, and once established, sends the current registration information the server. Preferably, the registration server returns licensing information, which allows the transport protocol to fully function. If the registration step is not completed, the lack of licensing information will cause the transport protocol to function in a demonstration mode, which will in turn limit the present invention to a fixed number of allowable trading partner profiles, preferably 5, and which will prevent the ability of the present invention to be used on a network, in which the trading partner profile data table 413 may be located on a remote system. Step 1805 next updates the data in trading partner profile table 413, if applicable, which then results in the full functionality of the transport protocol.

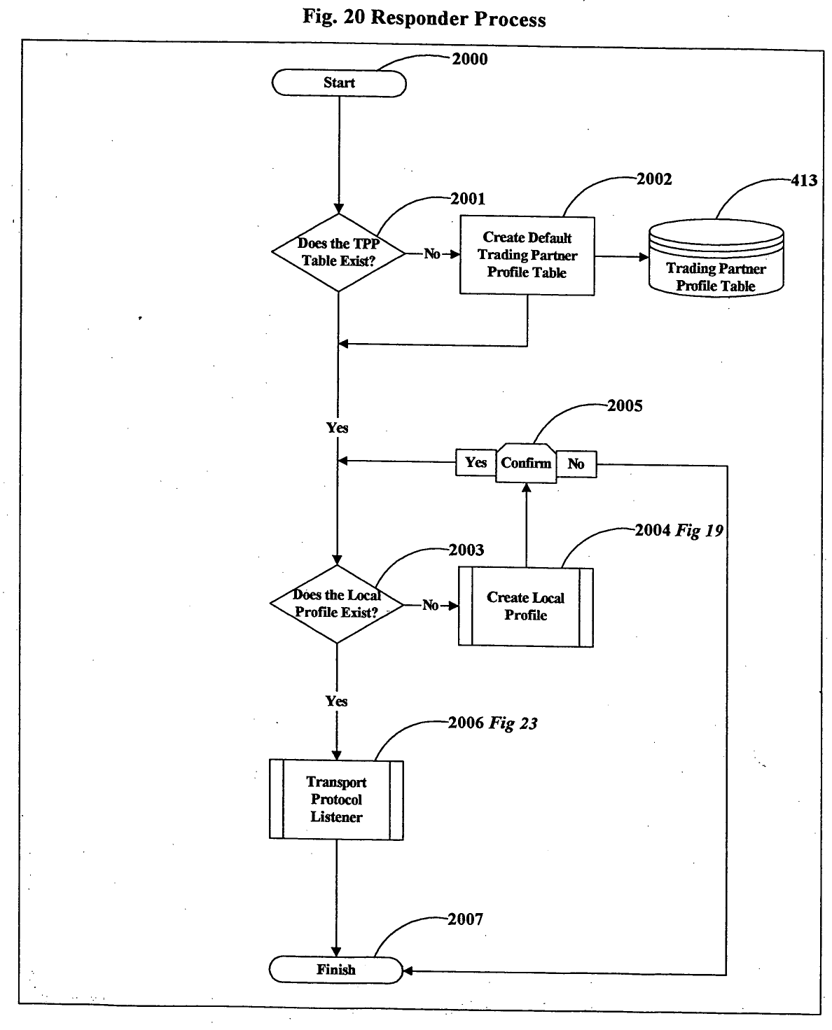

Next, step 1806 registers the responder server process with the systems startup group. Preferably, this step will result in the starting of the responder process each time commerce server 103 is activated. Next, step 1807 starts the responder server process which is further shown in FIG. 20.

FIG. 20 shows a flow diagram of the responder process. Beginning at start block 2000 of FIG. 20, step 2001 determines if the trading partner profile table 413 exists. If table 413 does not exist, a new table is created (step 2002) and control continues to step 2003. If step 2001 determines that table 413 does exist, step 2003 checks trading partner profile table 413 for the existence of a local profile within the table. If no local profile record exists, step 2004 creates the local profile record by starting the create local profile process, as further shown in FIG. 19.

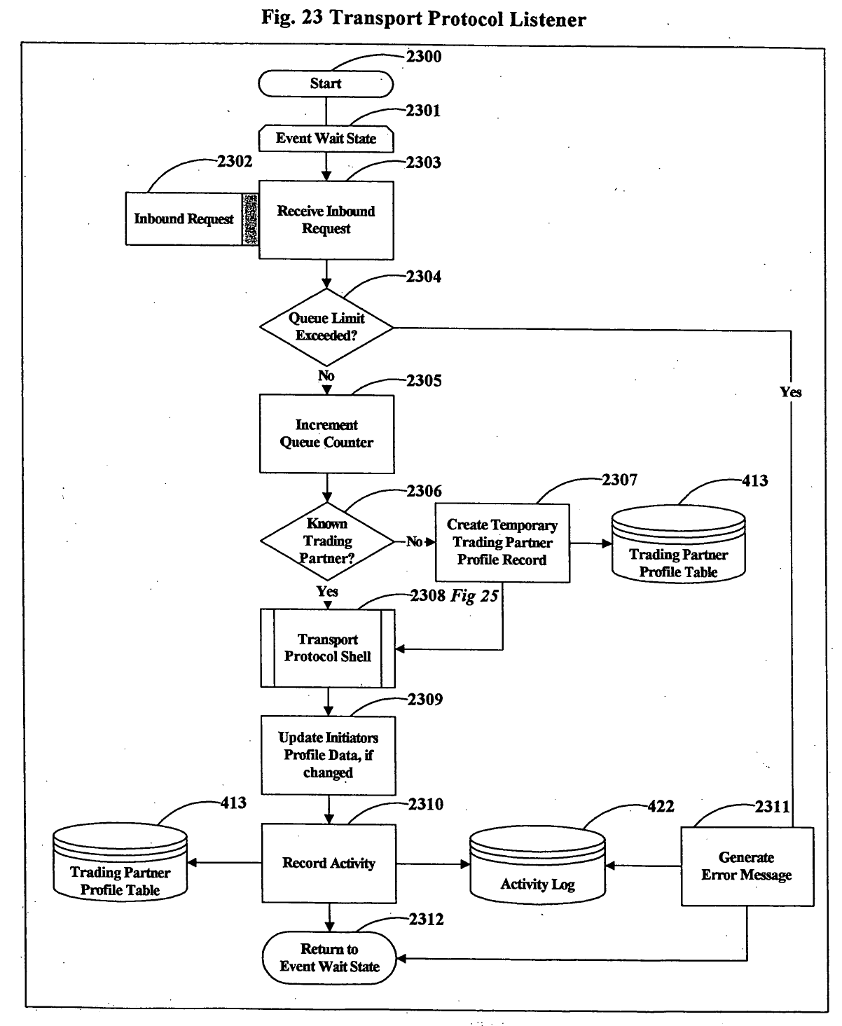

Once step 2004 is complete, step 2005 asks the user at commerce server 103 if the local profile record is to be written to trading partner profile table 413. If the user indicates the local profile record is valid to write, the local profile record is stored in trading partner profile table 413 and control returns to step 2003. If, in step 2005, the user indicates the record is not to be stored, the local profile is discarded and control is directed to finish block 2007, bypassing the start of the transport protocol listener process. Once step 2003 determines there is a local profile record, control continues to step 2006, where the transport protocol listener process, as shown in FIG. 23, is initiated. Once step 2006 is completed, finish block 2007 of FIG. 20 is reached, and finish block 1808 of FIG. 18 is reached.

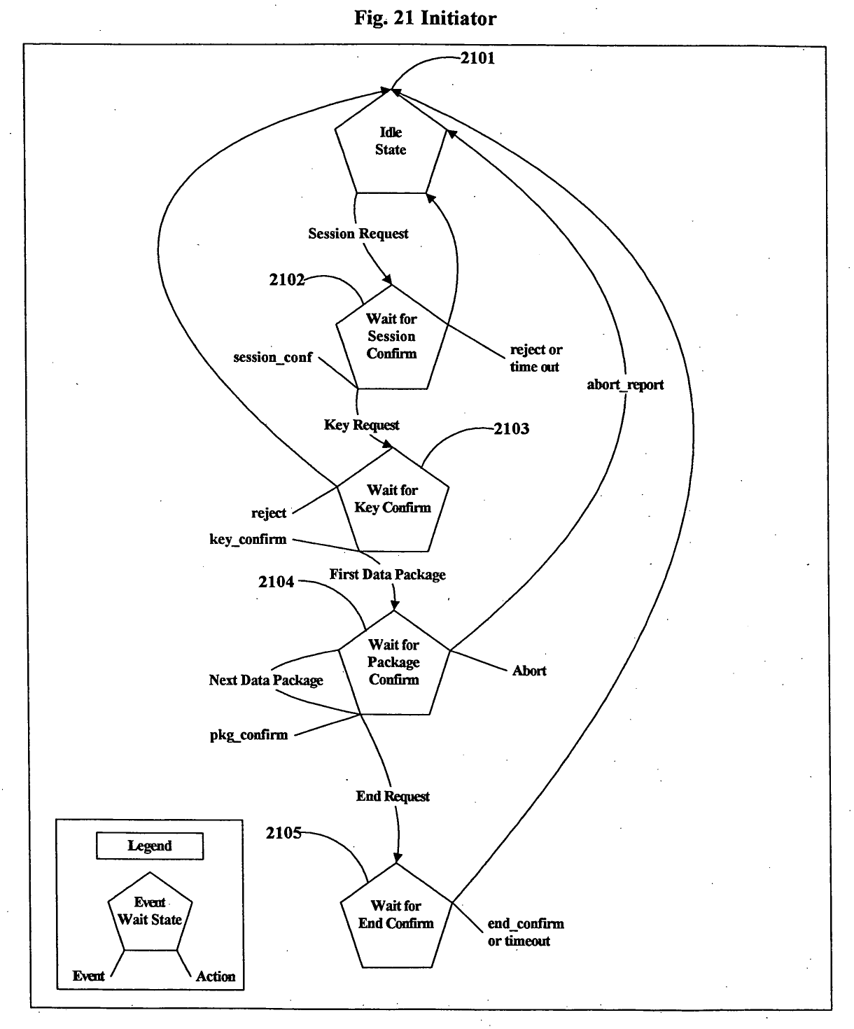

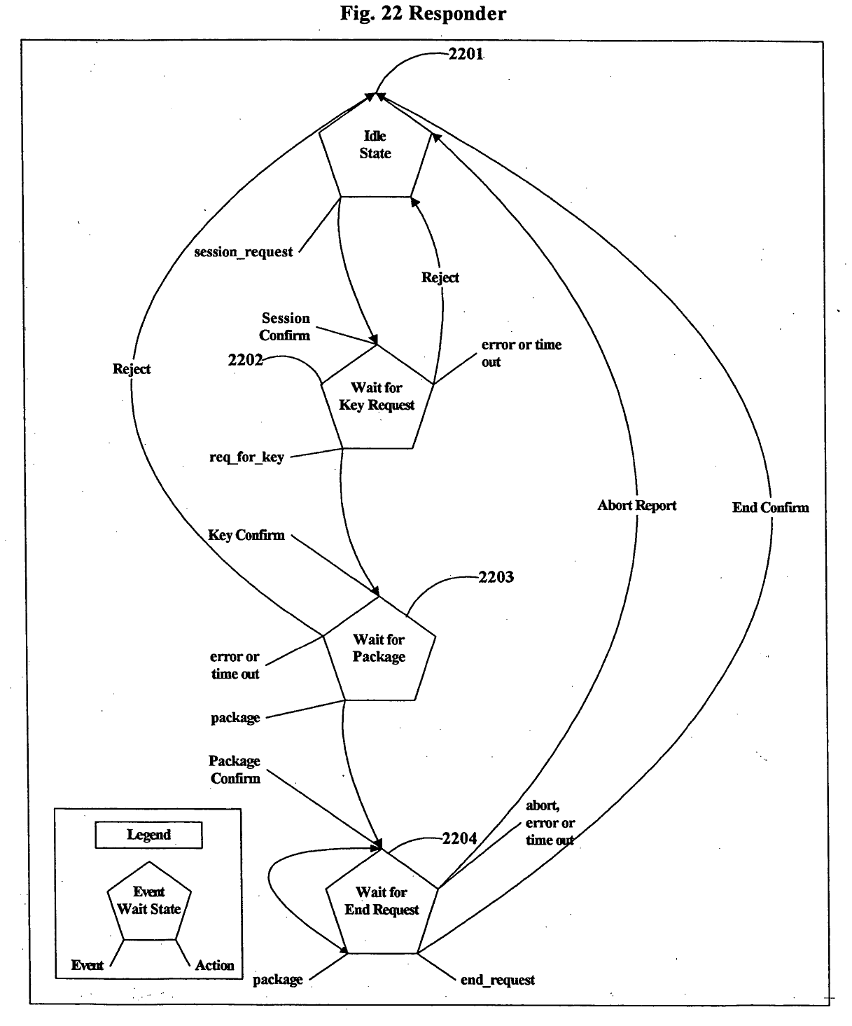

FIG. 21 and FIG. 22 are event state transition diagrams representing the initiator and the responder, respectively, of an exchange of data. These figures show the progression from event wait state to event wait state, the sequence of events needed, and the actions performed as a result of each event, in order to advance through the diagram and complete a session. A session begins with the initiator in state block 2101 of FIG. 21 and the responder in state block 2201 of FIG. 22. That same session ends with the initiator returning to state block 2101 and the responder returning to state block 2201, regardless of how the diagrams are traversed.

In a normal session the initiator, starting from state block 2101 of FIG. 21, sends a session request package, which includes the initiator's IP/port information and signature data. Once the session request package has been sent, control then moves to state block 2102.

The responder, after receiving the session request, checks the trading partner profile table 413 for the initiator's profile. If the profile is not found, the responder creates a temporary profile in the responder's trading partner profile table 413 to facilitate the initial exchange of data. If the profile is found, the responder then generates a new session key pair and replies with a session confirm, which includes the responder's public session key, signature and profile data. The responder then moves to state block 2202. This exchange establishes initial information and opens the TCP/IP communication path upon which to exchange encoded data.

After the initiator receives confirmation of the TCP/IP connection from the responder's session confirm, the initiator generates a session key pair and generates a key request, which includes the initiator's public session key, signature, and profile data. The key request is then encoded with the responder's public session key and sent to the responder. Additionally, if the responder's trading partner profile was not found in the initiator's trading partner profile table 413, or the information is old, the profile in the initiator's trading partner profile table 413 is updated with the responder's new profile, which is contained in the session confirm. The initiator then moves to state block 2103.

The responder, after receiving the key request, confirms the key request has been encoded correctly. A correct key request would preferably arrive encoded with the responder's public session key, and the responder would then determine whether the key request is correctly formatted after decoding. Additionally, if the initiator's trading partner profile was not found in the responder's trading partner profile table 413, or the information is old, the profile in the responder's table 413 is updated with the initiator's new profile, contained in the key request. Responder then sends a key confirm and moves to state block 2203.

At this point, along with the establishment of a highly secure TCP/IP connection through the exchange of public encryption keys created for this session, the trading partners involved in the exchange are identified. At each state throughout the exchange, if the established communications protocol is maintained, common problems such as bottlenecking, flooding and denial of service (DOS) attacks are eliminated. Additionally, a secure path of communication within the session is enforced. If the transport protocol is breached at any event wait state from either partner, an abort package is sent from the partner detecting the breach and both partners return to their respective idle states, ending the session.

The initiator, now waiting at state block 2103, then receives the key confirm, thereby allowing the exchange of data packages to proceed. The initiator sends a data package containing the transaction waiting to be sent, and moves to state block 2104. If additional data packages are waiting to be sent, the initiator remains in state block 2104. Otherwise, the initiator proceeds to state block 2105.

After receiving a data package, the responder replies with a package confirm and remains in state block 2104. If the initiator sends additional data packages, then each package sent receives a matching package confirm from the responder. This activity continues until the initiator sends an end request and moves to state block 2105. Both initiator and responder would then return to their respective idle states, and the session would end.

FIG. 23 is a flow diagram of the transport protocol listener, which establishes the responder process when a request arrives. Beginning at start block 2300 of FIG. 23, step 2301 shows the transport protocol listener in an event wait state. Step 2302, the arrival of a new request, triggers the processing of step 2303. In step 2303, the inbound session request is received. Step 2304 next checks a queue limit counter to determine if this request can be processed.

If the queue limit is exceeded, control continues to step 2311, where an error message is written to the activity log 422, the inbound request is dropped, and the listener process returns to the event wait state in step 2312. If the queue limit is not exceeded in step 2304, control continues at step 2305, where the queue limit counter is incremented.

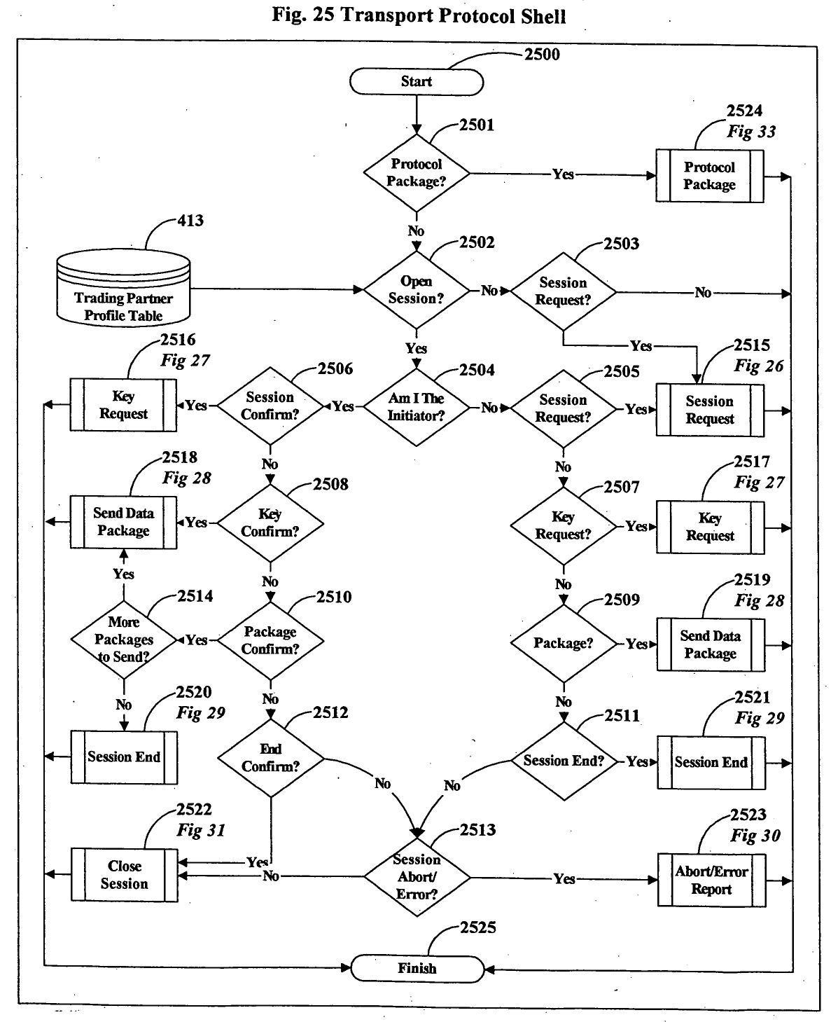

Step 2306, using data from table 413, determines if the initiator of the request has a current trading partner profile record. If the initiator's profile record is not found in table 413, a temporary profile record is added to table 413 to allow for the continued processing of this session and to facilitate the exchange of more detailed trading partner profile information. Once step 2307 completes, or once step 2306 determines the profile record is present in trading partner profile table 413, control continues to step 2308, where the transport protocol shell, further shown in FIG. 25, is initiated to handle the remainder of the communications exchange with the present trading partner. Step 2309 updates the initiator's profile data in trading partner profile table 413 and step 2310 writes the activity to activity log 422. Step 2312 returns the transport protocol listener to the event wait state.

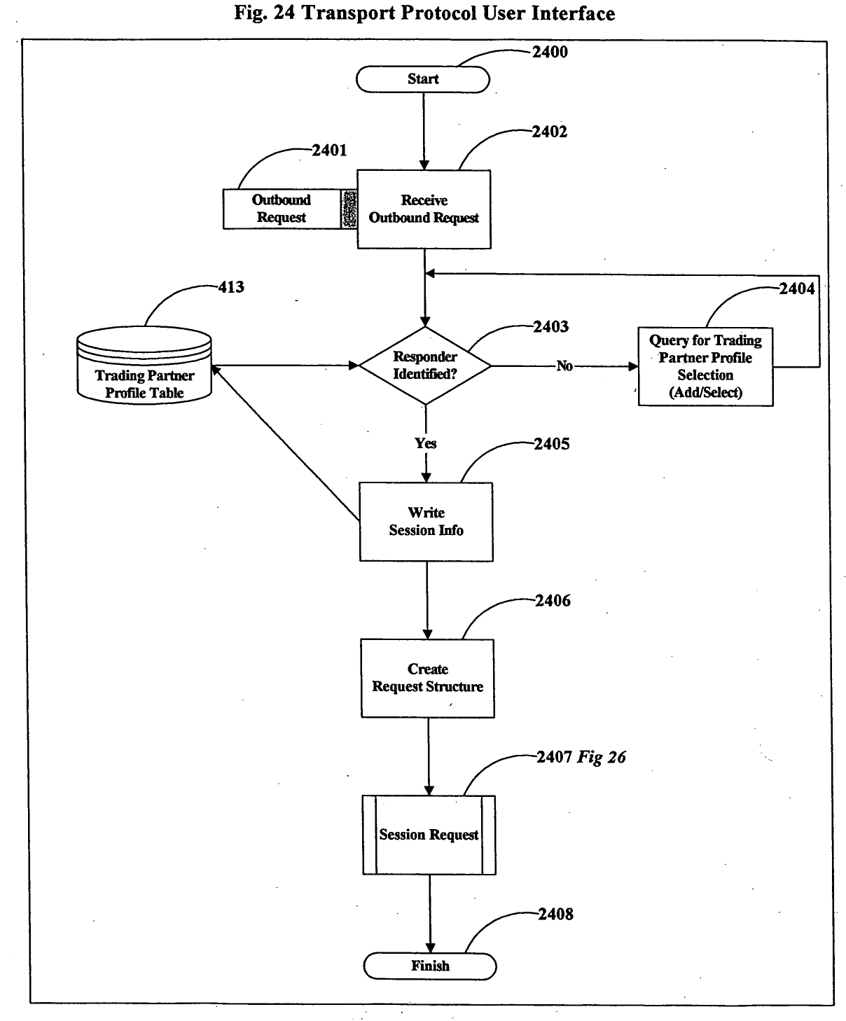

FIG. 24 is a flow diagram of the transport protocol's user interface. Beginning with start block 2400, an outbound request arrives in block 2401 and triggers step 2402 which receives the outbound request and validates the information to be sent. Step 2403 checks the trading partner profile table 413 to determine the responder to the request. If no responder is identified in the request, control continues to step 2404, where the user is queried to select a profile from trading partner profile table 413, after which control returns back to step 2403.

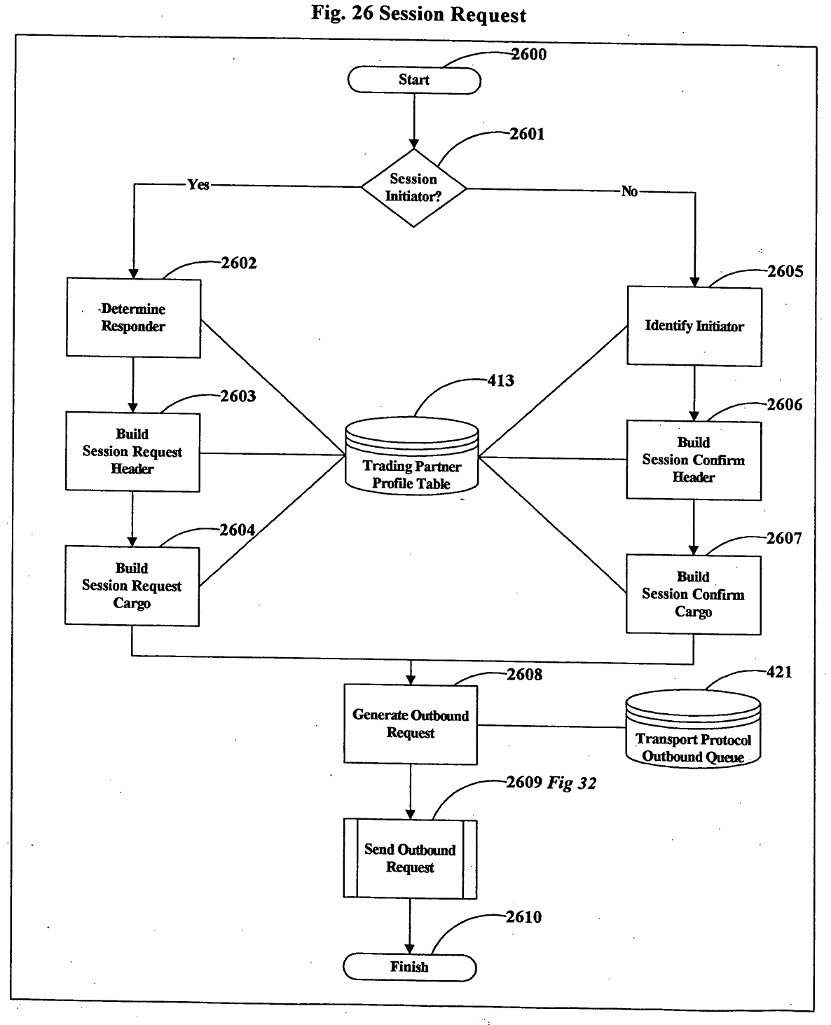

When step 2403 identifies the responder, control continues to step 2405, where session information, such as date and time, is recorded in trading partner profile table 413. Step 2406 then creates the request structure, and step 2407 initiates the session request, as further shown in FIG. 26. Once the session request ends, finish block 2408 is reached.

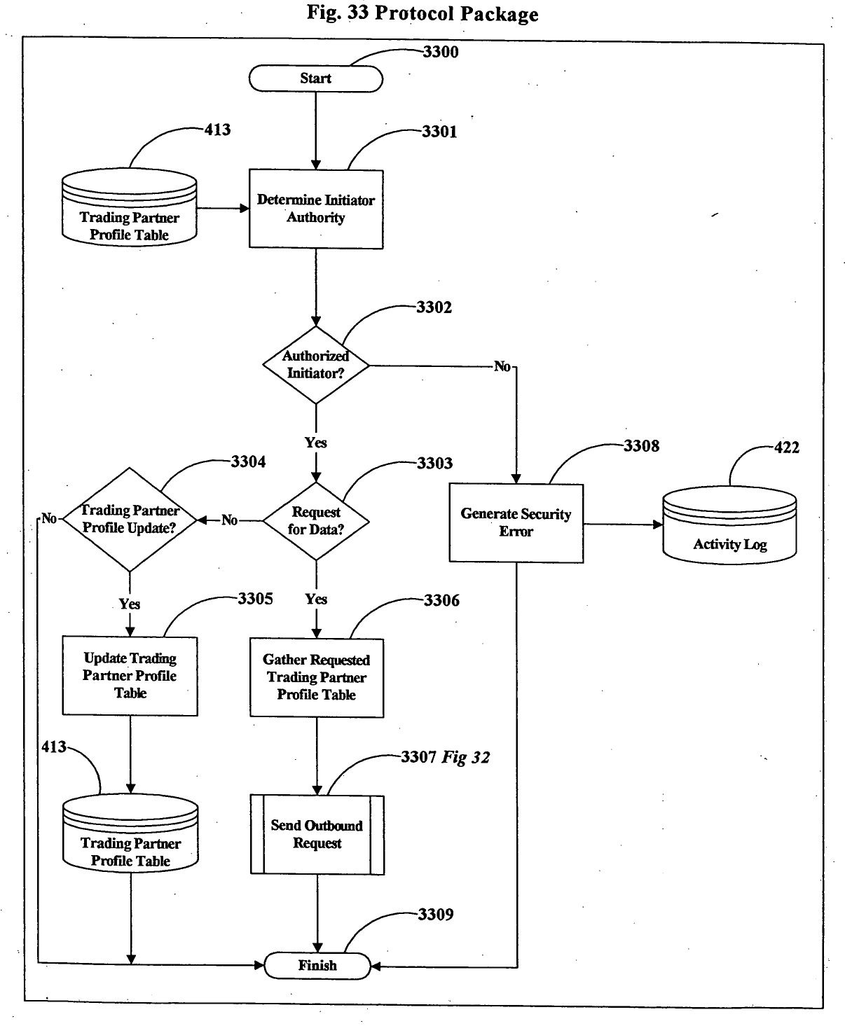

FIG. 25 is a flow diagram of the transport protocol shell which is initiated from the transport protocol listener of FIG. 23 each time an inbound request is received. The transport protocol shell remains active until the session is complete. Beginning from start block 2500 of FIG. 25, each time an inbound request is received during the session, step 2501 checks the request to determine if it contains a protocol package. If a protocol package is received in the request, step 2524 initiates the protocol package process. Step 2524 is further shown in FIG. 33. If the request does not contain a protocol package, step 2502, using data from table 413, determines the current session information for the trading partner sending the request.

If step 2502 determines a session has not been started, step 2503 examines the request to determine if it is a session request. If step 2503 determines the request does not contain a session request, the request is ignored and control moves to finish block 2525. If step 2503 determines a session request is present, control continues to step 2515, where the session request is initiated. Step 2515 is further shown in FIG. 26. Once the session request has finished in step 2515, finish block 2525 is reached.

If step 2502 determines a session has been started, control continues with step 2504, which determines the partner whom initiated the session. If step 2504 determines that system 100 is not the initiator, control continues with step 2505.

Step 2505 determines if a session request is present. If a session request is found, control continues with step 2515, where the session request is initiated, as further shown in FIG. 26. If a session request is not found in step 2505, control continues with step 2507.

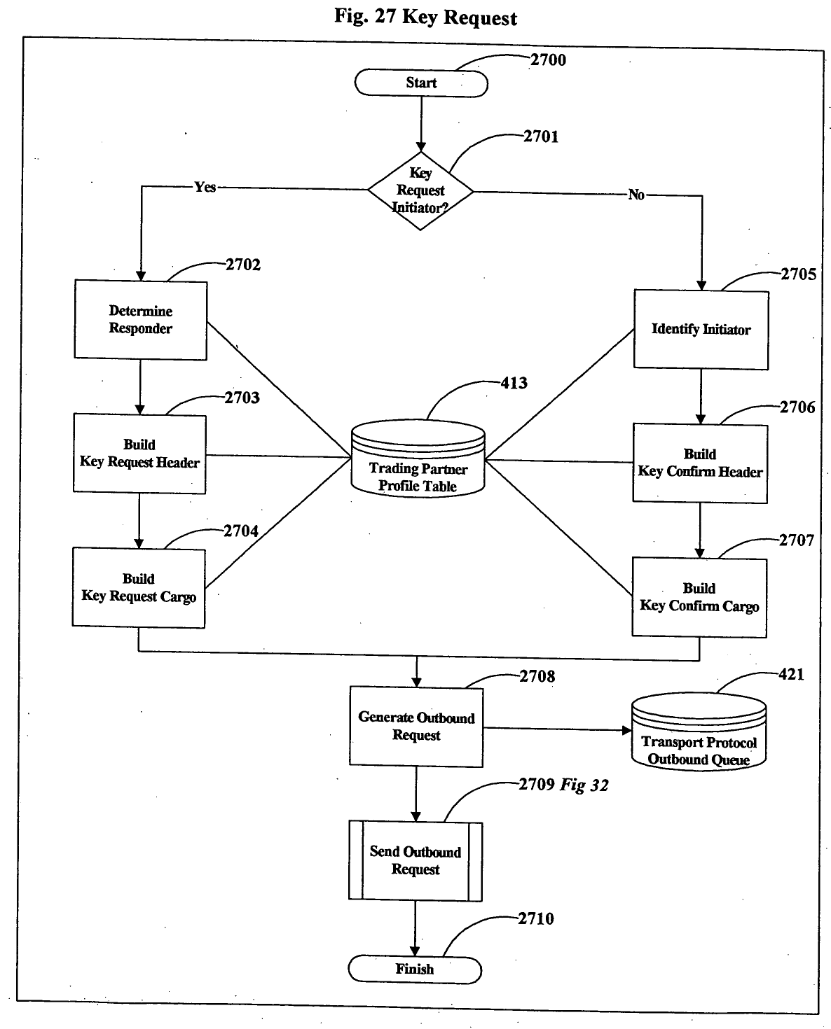

Step 2507 determines if a key request is present. If a key request is found, control continues with step 2517, where the key request is initiated. Step 2517 is further shown in FIG. 27. If a key request is not found in step 2507, control continues to step 2509.

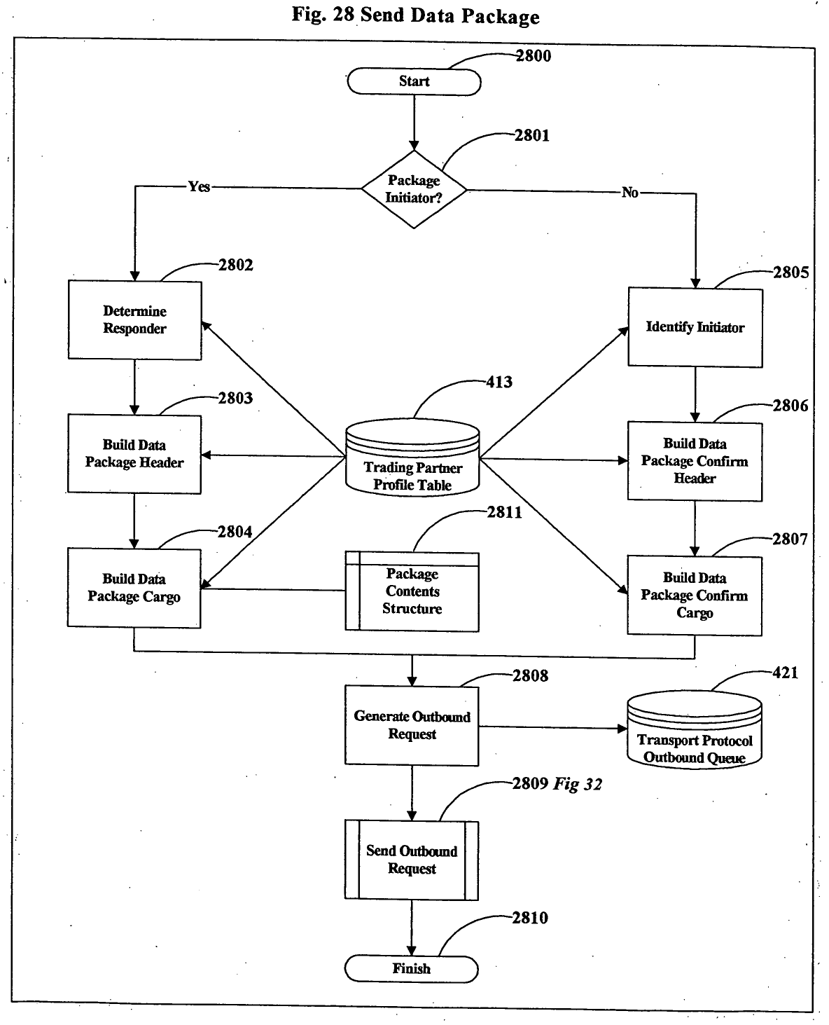

Step 2509 determines if a data package is present. If a data package is found, control continues to step 2519, where the send data package is initiated. Step 2519 is further shown in FIG. 28. If a data package is not found in step 2509, control continues to step 2511.

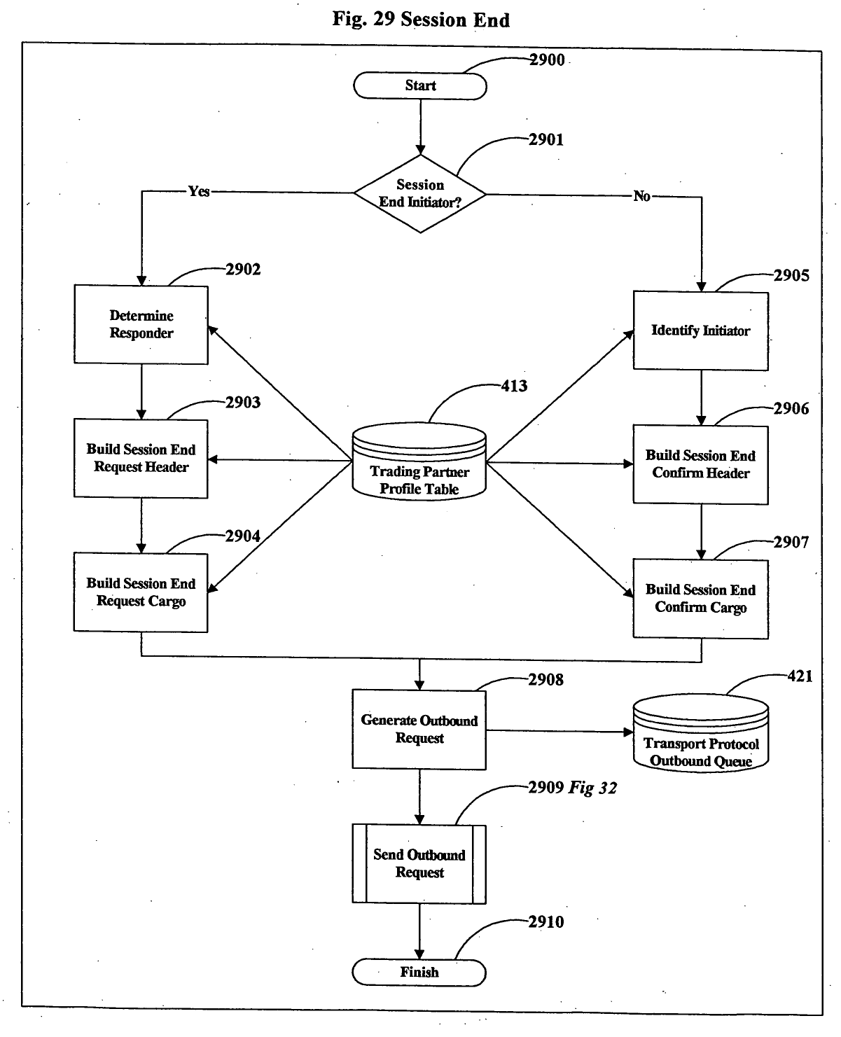

Step 2511 determines if a session end is present. If a session end is found, control continues to step 2521, where the session end is initiated. Step 2521 is further shown in FIG. 29. If a session end request is not found in step 2511, control continues to step 2513.

If step 2504 determines that system 100 is the initiator, control continues with step 2506.

Step 2506 determines if the package contains a session confirm. If a session confirm is found, control continues to step 2516, where the key request is processed. Step 2516 is further shown in FIG. 27. If a session confirm is not found in step 2506, control continues to step 2508.

Step 2508 determines if a key confirm is present. If a key confirm is found, control continues to step 2518, where the send data package is initiated. Step 2518 is further shown in FIG. 28. If a key confirm is not found in step 2508, control continues with step 2510.

Step 2510 determines if a package confirm is present. If a package confirm is found, control continues to step 2514. Step 2514 determines if there are more packages to send. If step 2514 determines that more data packages are to be sent, control continues to step 2518, where the sending of the next data package is initiated. If there are no more data packages to be sent, control continues to step 2520, where the session end is initiated. Step 2520 is further shown in FIG. 29. If a package confirm is not found in step 2510, control continues to step 2512.

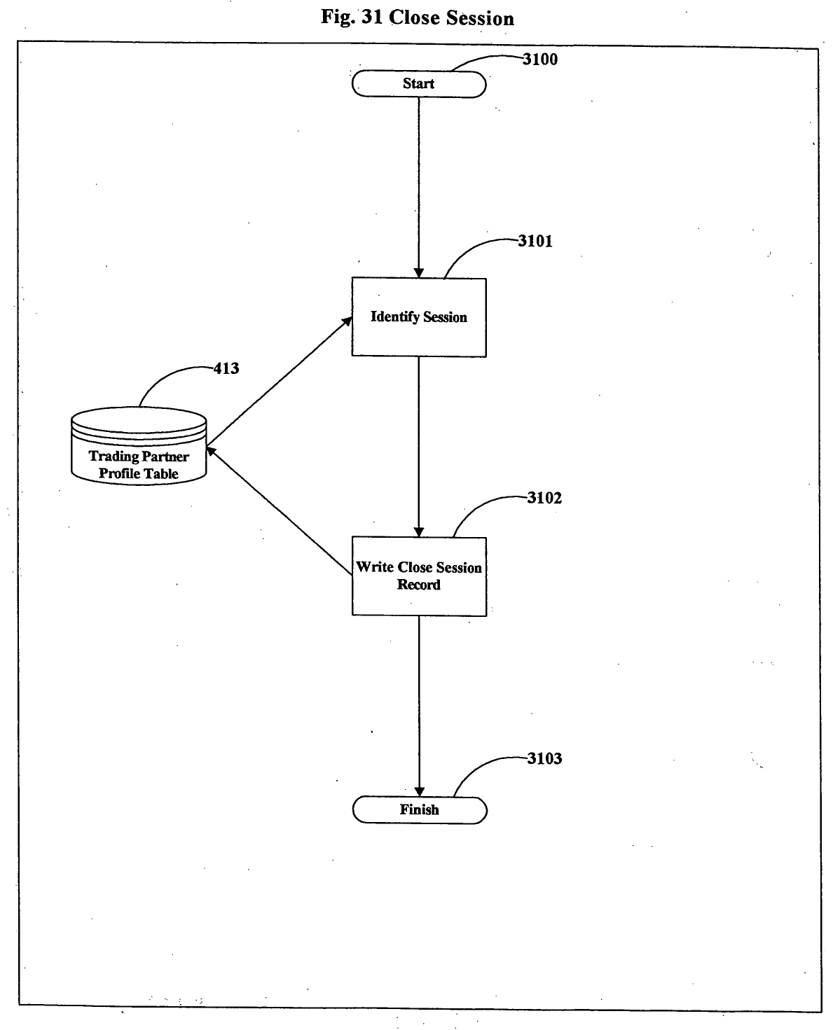

Step 2512 determines if an end confirm is present. If an end confirm is found, control continues with step 2522, where the close session is initiated, as further shown in FIG. 31. If an end confirm is not found in step 2512, control continues with step 2513.

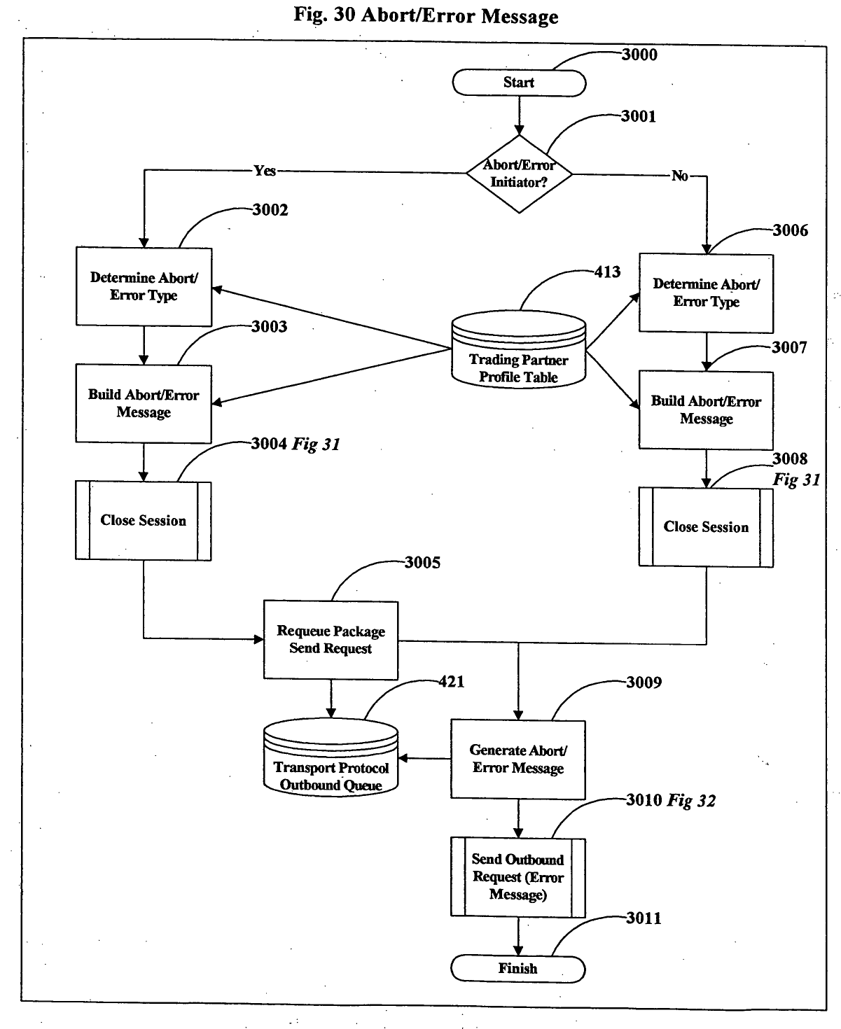

Step 2513 determines if a session abort/error is present. If a session abort/error is found, control continues to step 2523, where the abort/error report is initiated. Step 2523 is further shown in FIG. 30. If a session abort/error is not found in step 2513, control continues to step 2522, where the close session is initiated. Step 2522 is further shown in FIG. 31.

Beginning at start block 2600 of FIG. 26, step 2601 preliminarily determines the identity of the session initiator. If commerce server 103 is the initiator, control continues to step 2602, where the responder is identified. Step 2603 builds the session request header information. Step 2604 builds the session request cargo and control continues to step 2608.

If step 2601 determines the session was initiated by a trading partner found in table 413, control continues to step 2605, where the initiator is identified. Step 2606 builds the session confirm header, and step 2607 builds the session confirm cargo. Control then continues to step 2608.

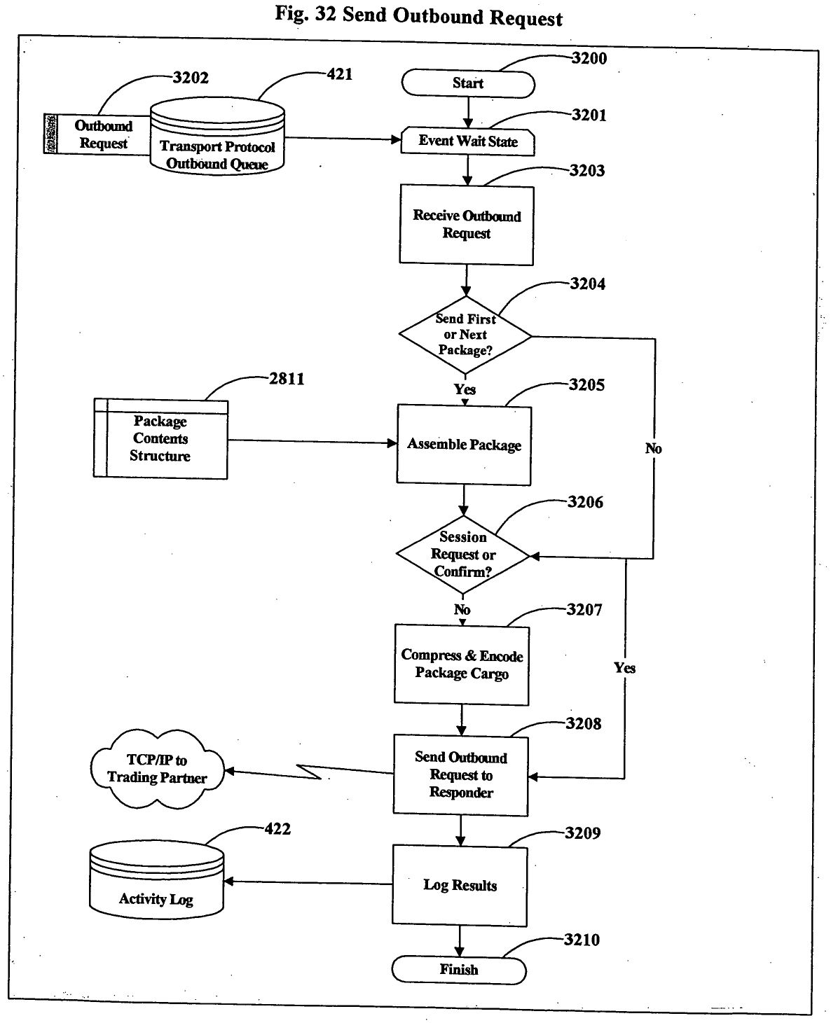

Step 2608 generates the outbound request and writes the request to transport protocol outbound queue 421. Step 2609 initiates the send outbound request, and is further shown in FIG. 32. After the send outbound request finishes in step 2609, finish block 2610 is reached.

FIG. 27 is a flow diagram of the key request process. Beginning at start block 2700 of FIG. 27, step 2701 determines the identity of the key request initiator. If commerce server 103 is the initiator, control continues to step 2702, which identifies the particular responder of the message. Step 2703 builds the key request header information, step 2704 builds the key request cargo, and control continues to step 2708.

If step 2701 determines the session was initiated by the trading partner, control continues with step 2705, where the initiator is identified. Step 2706 then builds the key confirm header. Step 2707 next builds the key confirm cargo and control continues with step 2708.

Step 2708 generates the outbound request and writes it to transport protocol outbound queue 421. Step 2709 initiates the send outbound request, as further shown in FIG. 32. Once the request has been sent in step 2709, finish block 2710 is reached.

FIG. 28 is a flow diagram of the send data package. Beginning at start block 2800 of FIG. 28, step 2801 determines the identity of the send data package initiator. If commerce server 103 is the initiator, control continues to step 2802, where the responder is identified. Step 2803 builds the data package header information, step 2804 builds the data package cargo, and control continues to step 2808.

If step 2801 determines that the session was initiated by a trading partner, then control continues to step 2805, where the particular initiator is identified. Step 2806 builds the data package confirm header, step 2807 builds the data package confirm cargo, and control continues to step 2808.

Step 2808 generates the outbound request and writes it to transport protocol outbound queue 421. Step 2809 initiates the send outbound request, as further shown in FIG. 32. Once the request has been sent to the trading partner, finish block 2810 is reached.

FIG. 29 is a flow diagram of the session end. Beginning at start block 2900 of FIG. 29, step 2901 determines the identity of the session initiator. If commerce server 103 is the initiator, control continues to step 2902, where the particular responder is identified. Step 2903 builds the session end request header and step 2904 builds the session end request cargo. After step 2904 is completed, control continues to step 2908.

If step 2901 determines the session was initiated by a trading partner, control continues to step 2905 where the particular initiator is identified. Step 2906 builds the session end confirm header and step 2907 builds the session end confirm cargo. Once step 2907 is completed, control continues to step 2908.

Step 2908 generates the outbound request and writes it to transport protocol outbound queue 421. Step 2909, further shown in FIG. 32, initiates the send outbound request. Once step 2909 is completed, finish block 2910 is reached.

FIG. 30 is a flow diagram of an abort/error message. Beginning at start block 3000 of FIG. 30, step 3001 determines the identity of the abort/error initiator. If commerce server 103 is the initiator, control continues to step 3002, where the abort/error type is determined. Step 3003 then builds the error or abort message, and step 3004, as further shown in FIG. 31, initiates the close session. Step 3005 writes a new request to transport protocol outbound queue 421 to re-queue the erred request. After step 3005 is complete, control continues to step 3009.

If step 3001 determines the session was initiated by a trading partner, step 3006 determines the type of error or abort, and step 3007 builds the error or abort reply message. Step 3008, as further shown in FIG. 31, then initiates a close of the current session. Once step 3008 is complete, control continues to step 3009.

Step 3009 generates the abort/error message and writes it to transport protocol outbound queue 421. Next, step 3010, further shown in FIG. 32, sends the message to the trading partner. Once step 3010 is complete, finish block 3011 is reached.

FIG. 31 is a flow diagram of the close session. Beginning at start block 3100 of FIG. 31, step 3101 identifies the session using data from trading partner profile table 413. Next, step 3102 writes information to table 413 indicating that the session is closed. Once step 3102 is completed, finish block 3103 is reached.

FIG. 32 is a flow diagram of the send outbound request. Beginning at start block 3200 of FIG. 32, step 3201 shows send outbound request in an event wait state. Step 3202, the arrival of an outbound request in the transport protocol outbound queue, triggers the processing of step 3203. Once triggered, step 3203 then receives the outbound request, and step 3204 determines if request contains a data package. If step 3204 determines that a data package is being sent, step 3205 assembles the package based on the package contents structure 2811. If step 3204 determines a data package is not present, control continues to step 3206.

Step 3206 determines whether the request is a session request or a session confirm. If the request is not a session request nor a session confirm, step 3207 compresses and encodes the package cargo using the public key obtained in the session confirm (for the responder), or the key request (for the initiator). If step 3206 determines that the request is a session request or session confirm, control continues to step 3208.

Step 3208 then sends the outbound request across network 104 to the trading partner, and step 3209 writes the results of the send to activity log 422. After step 3209 is complete, finish block 3210 is reached.

FIG. 33 is a flow diagram of the protocol package. From start block 3300 of FIG. 33, step 3301, using data from trading partner profile table 413, checks the authority of the initiator. Step 3302 then determines if the initiator is authorized. If initiator is not authorized, control continues to step 3308 where a security error message is written to activity log 422, and then the process ends at finish block 3309.

If step 3302 determines that the initiator is authorized to proceed, step 3303 then determines if the protocol package contains a request for data. If the protocol package does contain a request for data, step 3306 gathers the requested data from trading partner profile table 413 and step 3307 initiates the send outbound request. Step 3307 is further shown in FIG. 32. Once the outbound request has been sent, finish block 3309 is reached.

If step 3303 does not find a request for data in the protocol package, control continues to step 3304. Step 3304 then determines if the protocol package contains a trading partner profile update. If the package does not have an update, the process ends at finish block 3309. If step 3304 determines that a profile update is contained in the protocol package, step 3305 updates the information in table 413, and the process ends at finish block 3309.

In a business environment, the seed of every business transaction is sown with an exchange of information. This exchange, between trading partners, is known as a “business agreement” and would typically contain information similar to that described in EDI standards as the EDI838 Trading Partner Profile and the EDI868 Electronic Forms Structure. Once these two important sources of information are exchanged, the basis for all future exchanges of transactions is established.

The trading partner profile and electronic forms data are stored, along with additional data to facilitate a network connection, in the trading partner profile table 413 of FIG. 4. In essence, the trading partner profile table 413 allows the present invention to: 1) recognize each trading partner's business identity; 2) determine what mutually agreed upon transactions may be exchanged; 3) determine where the data is located within each transaction; and 4) determine the allowable values for each element of those transactions, every time an exchange of data with the trading partner occurs.

FIG. 34 is an overview of the inbound and outbound transaction flows, which occur in tandem, on the commerce server 103 of FIG. 1. Transactions move in a bi-directional flow, inbound and outbound, through the sub-processes, completing predetermined paths according to instructions found in the business transaction map 415 of FIG. 4.

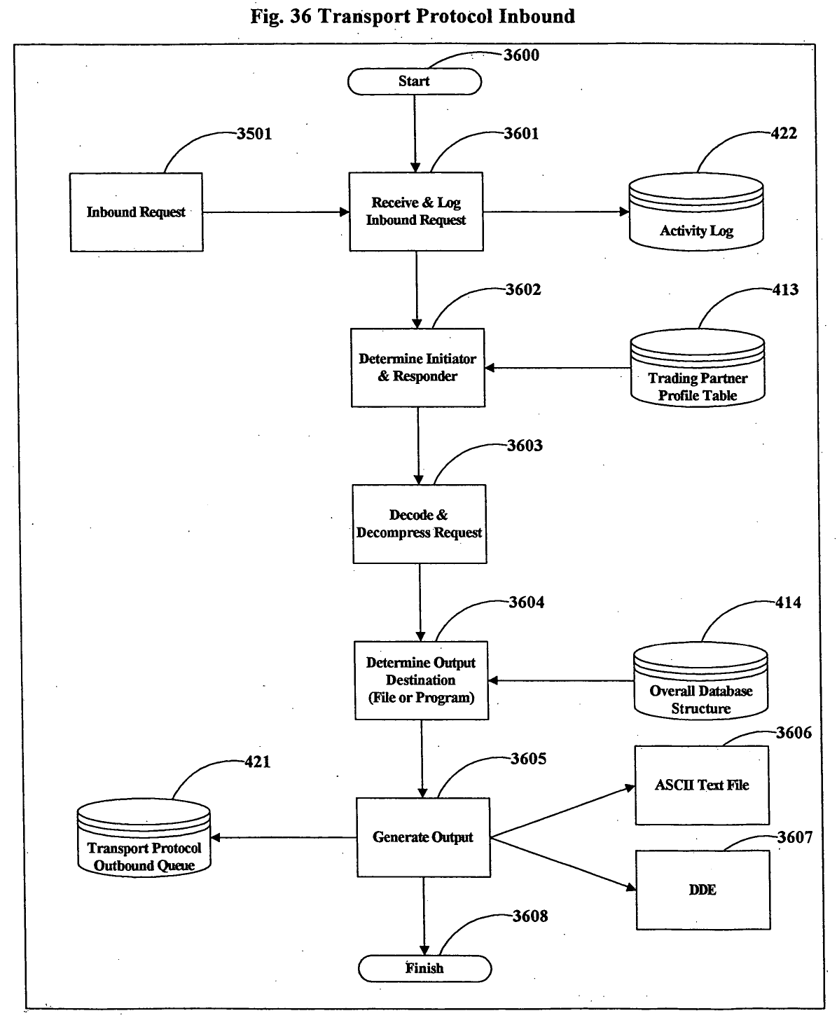

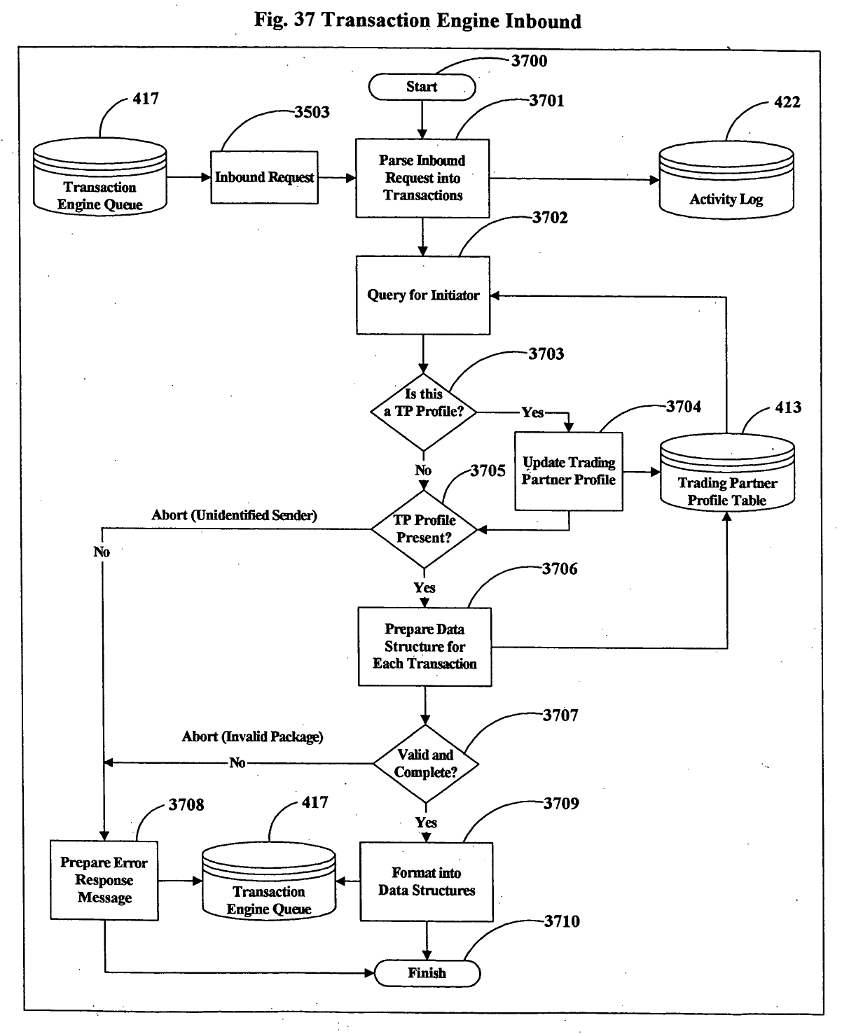

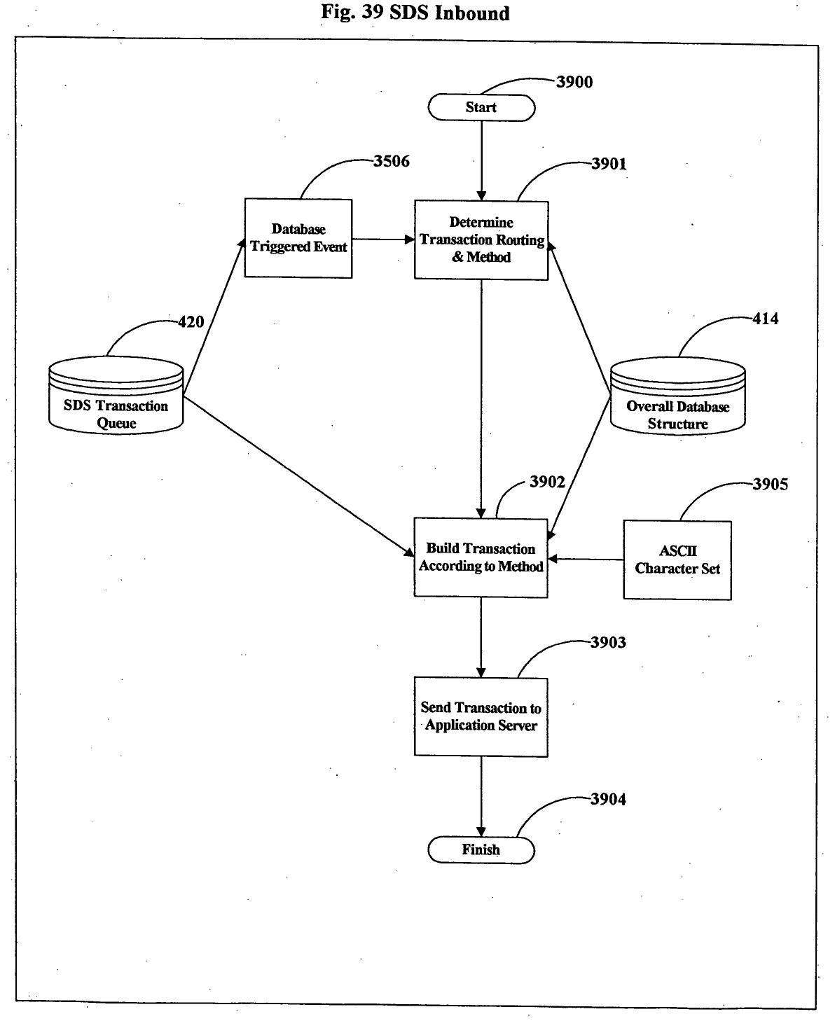

From start block 3400 of FIG. 34, inbound transactions coming from network 104 are received in step 3401, as further shown in FIG. 36, where they are unpacked, decoded and validated. The inbound transactions are then passed individually to step 3402, as further shown in FIG. 37, where each transaction is identified and parsed to internal data structures. Once completed, the data from step 3402 is passed to step 3403, which then determines what additional transactions are necessary to complete the business conversation. Step 3403 also routes those transactions to their appropriate destinations. Some of those transactions in step 3403 will continue to step 3404, which is further shown in FIG. 39. Finish block 3405 ends the inbound transaction flow.

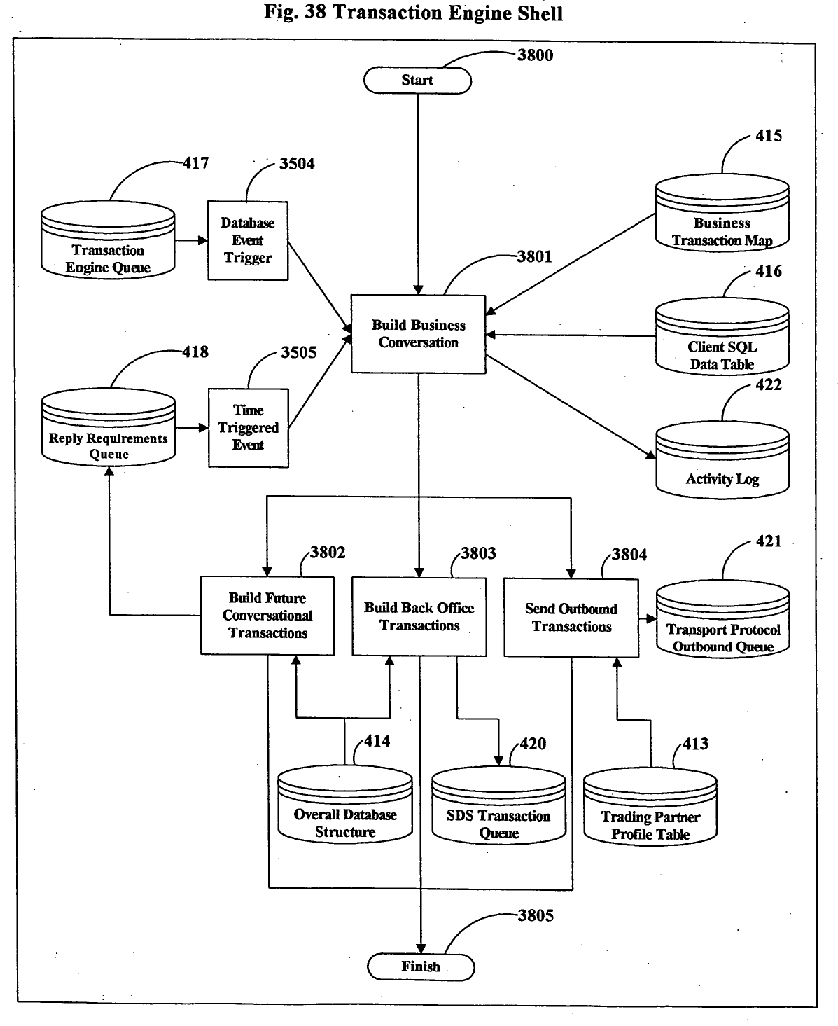

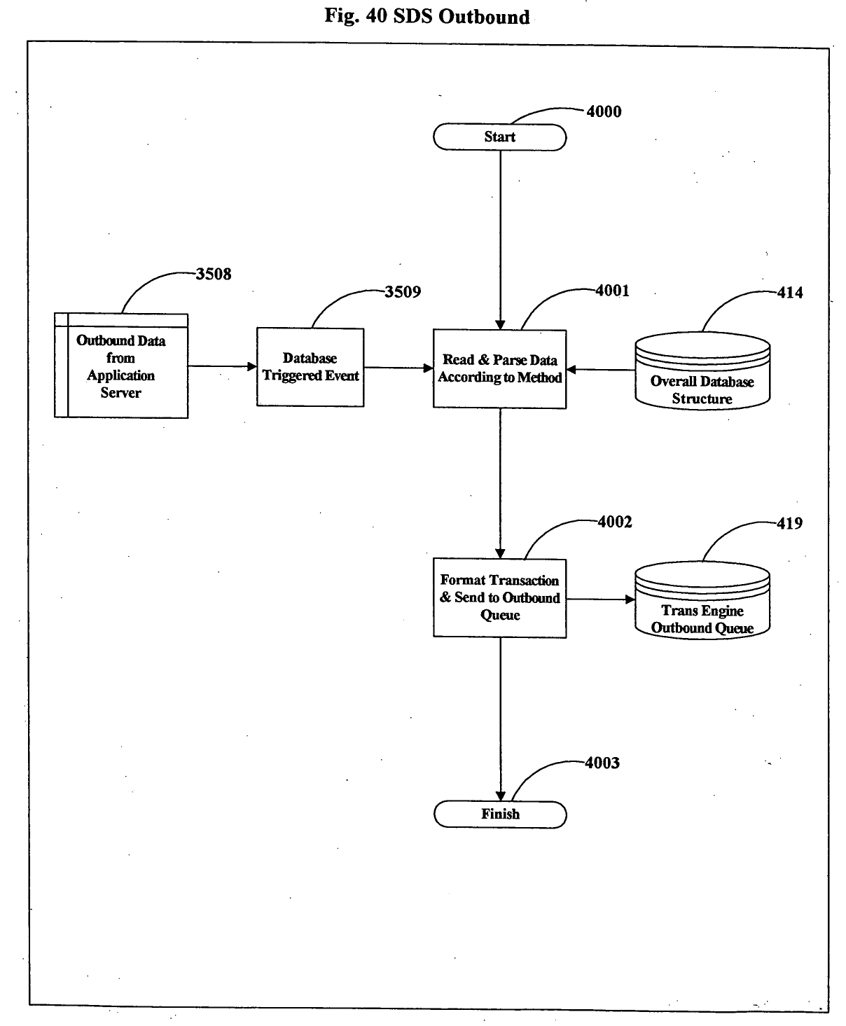

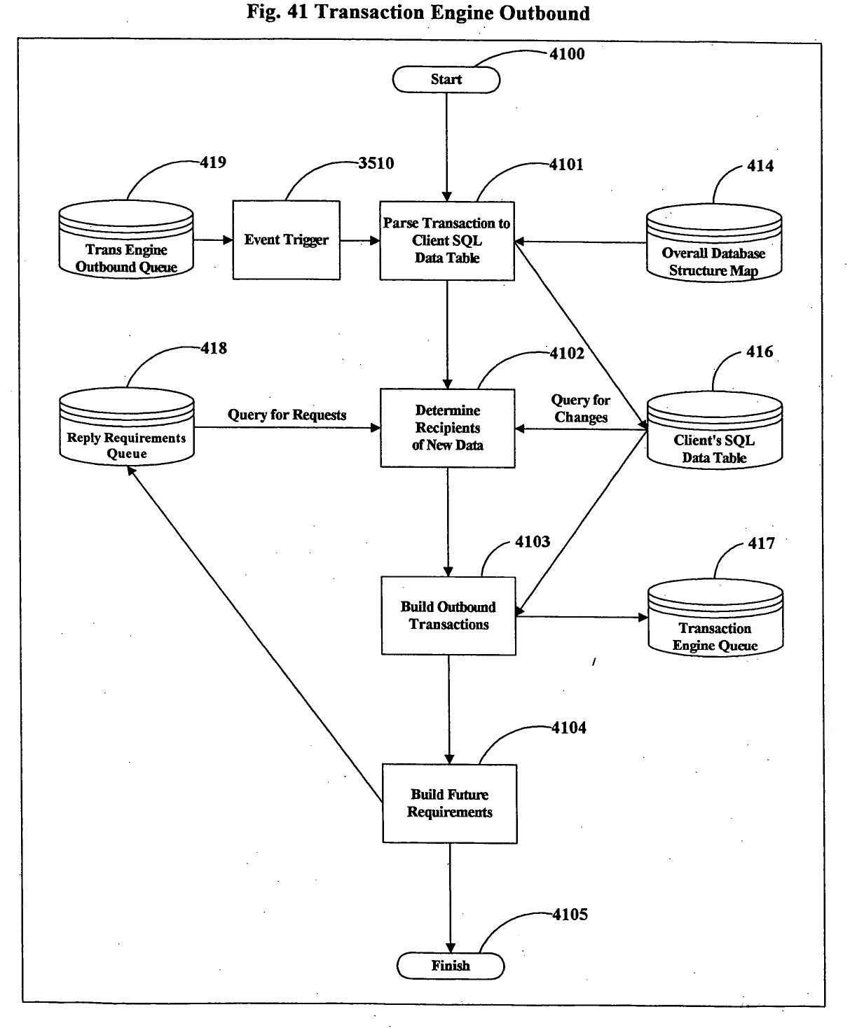

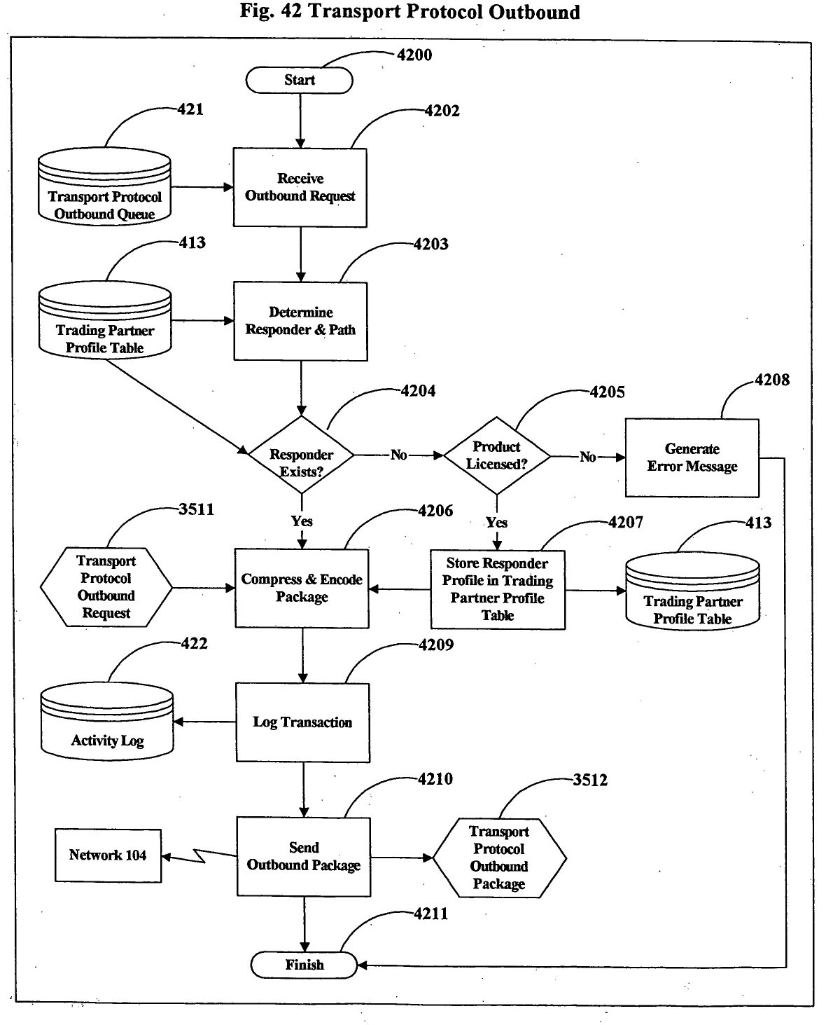

Additionally, from start block 3406 in FIG. 34, outbound transactions, preferably in the form of output data from application server 106, are received in step 3407. Step 3407, as further shown in FIG. 40, is where the data is parsed to an internal data structure and sent to step 3408. Step 3408, as further shown in FIG. 41, creates the client SQL table 416, if needed, and updates the table 416. Next, step 3403, as further shown in FIG. 38, determines what additional transactions are necessary to complete the business conversation and routes those transactions to their appropriate destinations. Some of those transactions in step 3403 will continue to step 3409, further shown in FIG. 42, where the transactions are packaged, encoded and sent across network 104 to their final destination. The outbound transaction flow ends at finish block 3410.

The inbound and outbound flow of transactions occur through the use of queues. Queues are files in which data is stored sequentially and retrieved in the order in which the data was stored, commonly known as the first in, first out rule. This allows each sub-process to process their respective data and pass it to the next sub-process independent of the need for the receiving sub-process to be actively waiting for this data. One advantage to this method is in the ability of each sub-process to re-queue a transaction when processing of the transaction is not possible due to timing or lack of needed data. The major advantage to this approach is that each component sub-process ensures that data being used or stored at any particular point in the present invention is not lost or corrupted. These sub-processes, each independent of the other, assume control of their respective queue file, and are aware of both content and size in each of the files. Events are triggered when a new request arrives in each sub-process queue. Each sub-process would then perform its inherent function and the data would subsequently move along the given transaction flows.

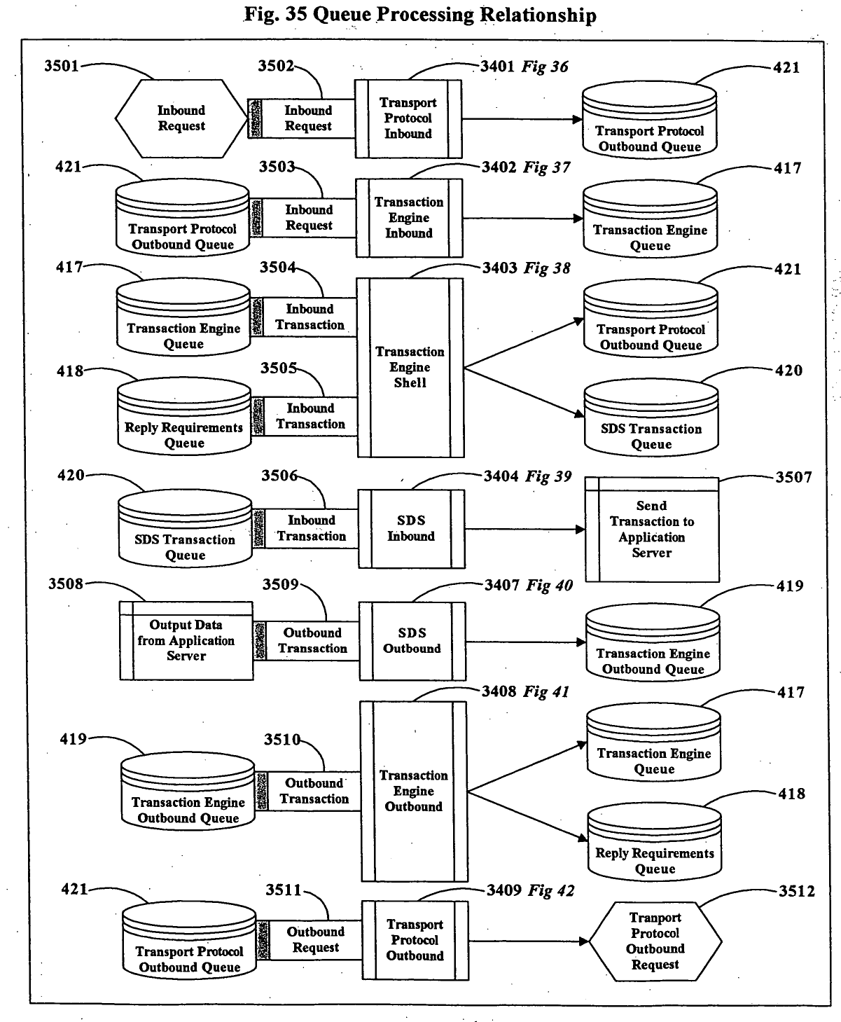

FIG. 34 is a diagram of the overall flow of transactions through the present invention and FIG. 35 is a diagram of the flow of transactions through the individual sub-processes. Since each sub-process is an independent part of the transaction engine flow, each sub-process is described hereinafter as separate from each other.

The first process flow shown in FIG. 35 begins at inbound request 3501. The inbound request 3501 is the event trigger for step 3502 which in turn initiates step 3401. Step 3401 is further shown in FIG. 36. The process flow in step 3401 results in the update of the transport protocol outbound queue 421 with the inbound request.

From start block 3600 of FIG. 36, step 3601 receives and unpacks the inbound request and logs the request in activity log 422. Next, in step 3602, the initiator and responder are determined using the trading partner profile table 413. Step 3603 then decodes and decompresses the request using a preestablished and exchanged pair of encryption keys. Next, step 3604, using overall database structure 414, determines the output destination of the contents of the inbound request. The destination of the contents would be located in any allowable directory, on any compatible device connected to network 105, and would include, but not be limited to an ASCII text file or a dynamic data exchange (DDE) which is electronically passed to any program which allows DDE and has been given the rights to execute such a file. Further, if the inbound request is EDI structured, step 3605 sends a standard EDI997 functional reply to the transport protocol outbound queue 421 to confirm receipt of the request. Then, in step 3606, the contents are output to the determined destination, either in file format as shown in block 3606, or in DDE format as in block 3607. The sub-process ends at finish block 3608. The transaction engine inbound process, as further shown in FIG. 37, is the preferred destination of the inbound transaction.

The next sub-process in FIG. 35 begins with the receipt of an inbound request 3503 in the transport protocol outbound queue 421, which is the event trigger. Step 3503 triggers the transaction engine inbound process, step 3402, which is further shown in FIG. 37. This sub-process results in update of the transaction engine queue 417.

From start block 3700, inbound request 3503 triggers step 3701 where the request is parsed into individual transactions and a record of the inbound request is written to activity log 422. Step 3702 then queries the trading partner profile table 413 for the initiator's existing profile data. Next, step 3703 checks the parsed transactions for a trading partner profile record. If step 3703 determines that no trading partner profile information is included in the transaction(s), then control continues to step 3705. If step 3703 determines that a trading partner profile record is included in the transaction(s), then step 3704 determines if the initiator's profile and all necessary information, such as allowed contents and formats, is present, and uses the information to update the trading partner profile table 413. Control then continues to step 3705.

Step 3705, using data from table 413, determines if the initiator has a profile present. If step 3705 determines that the initiator has not supplied a valid or complete trading partner profile, control would continue to step 3708. An example of a profile that is not a valid or complete trading partner profile is one that does not have information contained in the EDI868, information that would describe the contents and structure of a transaction included in the inbound request. After an error message is sent to the transaction engine queue 417 in step 3708, the process ends at finish block 3710. If step 3705 determines that the initiator has a valid and complete trading partner profile in table 413, step 3706 prepares a data structure for each transaction. Step 3707 then determines whether or not the parsed transactions are valid and complete by comparing the contents to the pre-defined data structure. If step 3707 determines that any one of the transactions is invalid or incomplete, then step 3708 prepares an error response message and sends the error message to. the transaction engine queue 417. Once step 3708 has sent the error message, the process ends at finish block 3710. If step 3707 determines that all parsed transactions are valid and complete, step 3709 formats the data to a pre-defined data structure and sends the transaction to the transaction engine queue 417. Once the transaction has been sent to queue 417, the process ends at finish block 3710.

The next sub-process shown in FIG. 35 begins with a transaction arriving in the transaction engine queue 417. An event trigger, inbound transaction 3504, initiates step 3403, which is further shown in FIG. 38.

FIG. 38 is a flow diagram of the transaction engine shell. Beginning at start block 3800, a transaction arrives either in the transaction engine queue 417 or the reply requirements queue 419 and triggers step 3801. Step 3801 first writes the transaction to the activity log 422 then step 3801, using data from the business transaction map 415, the client SQL data table 416, and the reply requirements queue 419, determines the destination of the transaction (Inbound to the back office application, or outbound to a trading partner), and any additional transactions needed to complete the business conversation. For example, a purchase order transaction will be followed by an invoice transaction, and an invoice transaction will be followed by a payment authorization transaction. In addition, a business conversation may also include an exchange of confirmations for each of the above example transactions.

Additional requirements processed in step 3801 consist of transactions that are yet to be processed by the application server 106, transactions that are determined ready to be sent out to trading partners, transactions that are determined to be processed in the future, and transactions that are incomplete. As necessary, the results of step 3801 are sent to and processed concurrently in steps 3802, 3803, and 3804.

In step 3802, any transaction which must wait to be processed or that is considered incomplete due to its lack of required data, is written to the reply requirements queue 418 for future processing. In step 3803, any transaction being sent to the application server 106 is formatted and written to the SDS transaction queue 420. In step 3804 any transaction ready to send to the trading partner is formatted and written to the transport protocol outbound queue 421. Steps 3802, 3803 and 3804 end concurrently at finish block 3805.

The next sub-process shown in FIG. 35 begins with a transaction arriving in the reply requirements queue 418. An event trigger, step 3505, initiates step 3403, which is further shown in FIG. 38.

The next sub-process shown in FIG. 35 begins with a transaction arriving in the SDS transaction queue 420. Event trigger 3506, initiates step 3404, which is further shown in FIG. 39.

FIG. 39 is a flow diagram of the SDS inbound. From start block 3900, step 3901 receives and reads the transaction and, using data from overall database structure 414, determines the routing path and presentation method for processing the transaction. The presentation method preferably includes a choice of: the direct application of data to an identified database, the dynamic data exchange (DDE) with another application, the output of data as text to a file, or the presentation of the data to the graphical user interface of the back office application 509 in the form of simulated keystrokes. Step 3902, using data from overall database structure 414, formats the transaction according to the method determined, and step 3903 sends the transaction to the application server 106 according to the determined method. Once step 3903 is complete, the process ends at finish block 3904.

The next sub-process flow shown in FIG. 35 begins with the receipt of the outbound transaction 3508 created by application server 106 in step 3508. The outbound transaction 3508 is the event trigger 3509 initiates step 3407 which is further shown in FIG. 40. Additionally, files created by the back office application 509 can also be an outbound transaction 3508 and act as an event trigger. These files, from the back office application 509, preferably initiate step 3407 at a predetermined interval of time.

FIG. 40 is a flow diagram of the SDS Outbound. From start block 4000, step 4001 receives, reads and parses the outbound data 3508 found in the outbound transaction 3509, using the overall database structure 414 to determine the structure and location of the data. Next, step 4002 formats the transaction and writes the transaction to the transaction engine outbound queue 419. The process ends at finish block 4003.

The next sub-process shown in FIG. 35 begins with an outbound transaction 3510 arriving in the transaction engine outbound queue 419. Outbound transaction 3510 initiates step 3408, which is further shown in FIG. 41.

FIG. 41 is a flow diagram of the transaction engine outbound. Beginning at start block 4100, an outbound transaction 3510 arrives in the transaction engine outbound queue 419 and initiates step 4101. Step 4101, using data from the overall database structure map 414, parses the outbound data to the client's SQL data table 416. Step 4102, using both data from the outbound transaction 3510, now residing in the client SQL data table 416, and from the reply requirements queue 418, determines if this transaction is related to a prior future requirement in the reply requirements queue 418. If step 4102 determines that any data is required to process the current outbound transaction, then step 4103 builds new outbound requests, whose requirements have been fulfilled, to the transaction engine queue 417. Step 4104 then writes to the reply requirements queue 418 any future transaction requirements needed to complete the business conversation related to this transaction. The process ends with finish block 4105.

The next sub-process in FIG. 35 begins with an outbound request 3511 arriving in the transport protocol outbound queue 421 and which results in the initiation of step 3409. In step 3511, an outbound request arrives and initiates step 3409, which is further shown in FIG. 42.

FIG. 42 is a flow diagram of the transport protocol outbound. From start block 4200, an outbound request 3511 arrives in the transport protocol outbound queue 421 and triggers receipt of the request in step 4202. Step 4203, using data from trading partner profile table 413, then determines the responder and forwarding path details. Step 4204 next determines if the responder exists in trading partner profile table 413. If the responder does not exist in table 413, step 4205 determines the license status of the product. If the product is licensed, step 4207 stores the new responder information in trading partner profile table 413 and continues to step 4206. If the product is not licensed, step 4208 generates an error message, sends the message to the originating process, and the process ends at finish block 4211. If step 4204 determines that the responder exists in trading partner profile table 413, then step 4206 compresses and encodes the package, step 4209 writes the outbound request to the activity log 422 and step 4210 sends the request to the responder over network 104. The process ends at finish block 4211.

1. A method for communicating a transaction between an originating computer and a destination computer, the method comprising the steps of
processing transaction data from an application suite at the originating computer;
generating standardized data transactions based on predefined definitions;
sending the standardized transaction data from the originating computer to the destination computer;
receiving the standardized transaction data by the destination computer;
generating transaction data based on the attributes of the destination computer and storing the transaction data at the destination computer; and,
processing the transaction data by a target application suite at the destination computer.

2. The method for communicating a transaction as in claim 1, wherein the generating transaction data step comprises converting the transaction data from its original format to a standardized format.

3. The method for communicating a transaction as in claim 2, wherein the generating transaction data step converts the data from the standardized format to a format readable by the target application suite.

4. The method for communicating a transaction as in claim 1, the generating standardized data transactions comprising creating unique encryption keys for encoding and decoding transaction data.

5. A system for communicating a transaction between an originating computer, the originating computer comprising a computer usable medium having computer readable instruction code means stored therein, and a destination computer, the destination computer comprising a computer usable medium having computer readable instruction code means stored therein, the system comprising the steps of
computer readable instruction code means for processing transaction data from an application suite at the originating computer;
computer readable instruction code means for generating standardized data transactions based on predefined definitions;
computer readable instruction code means for sending the standardized transaction data from the originating computer to the destination computer;
computer readable instruction code means for receiving the standardized transaction data by the destination computer;
computer readable instruction code means for generating transaction data based on the attributes of the destination computer and storing the transaction data at the destination computer; and,
computer readable instruction code means for processing the transaction data by a target application suite at the destination computer.

6-82 (cancelled).
